(19) United States
(12) Patent Application Publication
(10) Pub. No.: US 2025/0038912 A1
(43) Pub. Date: Jan. 30, 2025

(54) Advanced Beamforming and Transmission Techniques for MIMO URLLC Applications

(71) Applicant: Huawei Technologies Co., Ltd., Shenzhen (CN)

(72) Inventors: Md Atiqul Islam, Chicago, IL (US); Jialing Liu, Palatine, IL (US); Narayan Prasad, Westfield, NJ (US); Weimin Xiao, Hoffman Estates, IL (US); Guosen Yue, Edison, NJ (US)

(21) Appl. No.: 18/887,890

(22) Filed: Sep. 17, 2024

Related U.S. Application Data
(63) Continuation of application No. PCT/US2023/015665, filed on Mar. 20, 2023.
(60) Provisional application No. 63/321,524, filed on Mar. 18, 2022.

(51) Int. Cl. H04L 5/00; H04B 7/06; H04W 24/10

(52) U.S. Cl. CPC H04L 5/0048; H04L 5/0007; H04L 5/0025; H04W 24/10; H04B 7/0617

(57) ABSTRACT

Methods, apparatuses, and computer-readable storage media are provided. An example method includes determining R demodulation reference signal (DMRS) ports for a transmission. R is greater than or equal to 2. The method includes determining N sets of one or more time-frequency domain resources for the transmission. N is greater than or equal to 1. The method includes determining RxN resource units on the R DMRS ports and the N sets of one or more time-frequency domain resources. RxN is greater than or equal to 3. The method includes mapping S complex-valued modulation symbols to the RxN resource units. The mapping is based on certain properties. The method includes transmitting, to an apparatus, the S complex-valued modulation symbols over the RxN resource units on the N sets of time-frequency domain resources based on the mapping and using the R DMRS ports.

### CROSS-REFERENCE TO RELATED APPLICATIONS

This application is a continuation of PCT/US2023/015665, filed on Mar. 20, 2023, and entitled “Advanced Beamforming and Transmission Techniques for MIMO URLLC Applications,” which claims priority to U.S. Provisional Application No. 63/321,524 filed on Mar. 18, 2022 and entitled “Advanced Beamforming and Transmission Techniques for MIMO URLLC Applications,” which applications are hereby incorporated herein by reference.

### TECHNICAL FIELD

The present disclosure relates generally to methods and apparatus for wireless communications and, in particular embodiments, to methods and apparatus for advanced beamforming and transmission techniques for multi-input multi-output (MIMO) ultra-reliable low-latency communication (URLLC) applications.

### BACKGROUND

Ultra-reliable low-latency communication (URLLC) is a new service category in 5th generation (5G) communications to accommodate emerging services and applications having stringent latency and reliability requirements. It is desirable to have substantial changes and improvements to communication techniques for 5G new radio (NR) in order to better support URLLC.

### SUMMARY

According to embodiments, a communication entity determines R demodulation reference signal (DMRS) ports for a transmission, for which R is greater than or equal to 2. The communication entity determines N set(s) of time-frequency domain resource(s) for the transmission, for which N is greater than or equal to 1. The communication entity determines RxN resource units on the R DMRS ports and the N set(s) of time-frequency domain resource(s). RxN is greater than or equal to 3.

The communication entity maps S complex-valued modulation symbols to the RxN resource units. S is less than RxN. For s from 1 to S, an s-th complex-valued modulation symbol is mapped to a quantity of r_s resource unit(s), r_s is greater than or equal to 1. For at least one s, r_s is greater than 1. RxN is greater than or equal to 5 if all r_s are equal.

The communication entity transmits, to an apparatus, the S complex-valued modulation symbols over the RxN resource units on the N set(s) of time-frequency domain resource(s) based on the mapping and using the R DMRS ports.

In some embodiments, R and N may be adaptively obtained based on channel condition information and ultra-reliable low latency communications (URLLC) requirements.

In some embodiments, the channel condition information may be obtained based on at least one of a sounding reference signal (SRS) or a channel state information (CSI) report received from the apparatus.

In some embodiments, each DMRS port of the R DMRS ports may correspond to a layer or transmission layer in a spatial domain.

In some embodiments, each resource unit of the RxN resource units may correspond to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in the time domain.

In some embodiments, the R DMRS ports may correspond to a subset of a set of the first number of antenna ports.

In some embodiments, each resource unit of the 3D resource grid may be uniquely identified by (r, k, l), for which r is a first index in the spatial domain, k is a second index in the frequency domain relative to a second reference point, and l is a third index in the time domain relative to a third reference point.

In some embodiments, the 3D resource grid may be defined for a first OFDM numerology including at least one of a subcarrier spacing value or a cyclic prefix value, a first carrier, and a first transmission direction of one of an uplink, downlink, or sidelink direction.

In some embodiments, the RxN resource units may include a first region configured as a spatial multiplexing region. A first complex-valued modulation symbol on the first region may be mapped to only 1 resource unit.

In some embodiments, the mapping the S complex-valued modulation symbols to the RxN resource units may include mapping a first set of one or more of the S complex-valued modulation symbols onto a subset of the resource unit(s) in the first region. A corresponding r_s is 1 for each of the first set of the one or more of the S complex-valued modulation symbols.

In some embodiments, the RxN resource units may include a second region configured as a diversity region. A second complex-valued modulation symbol on the second region may be mapped to more than 1 resource unit.

In some embodiments, the communication entity may map a second set of one or more of the S complex-valued modulation symbols onto a subset of the resource unit(s) in the second region. A corresponding r_s is greater than 1 for each of the second set of the one or more of the S complex-valued modulation symbols.

In some embodiments, the communication entity may map a second set of one or more of the S complex-valued modulation symbols onto a subset of the resource unit(s) in the second region, using at least one of Alamouti Code, Stacked Alamouti Code, Concatenated Alamouti Code, General Stacked Alamouti Code, Quasi-Orthogonal Space-Time Block Codes (QOSTBC), or Overlapped Alamouti Code.

In some embodiments, the second region may include at least one sub-region, and each of the at least one sub-region is one of an Alamouti Code sub-region, a Stacked Alamouti Code sub-region, a Concatenated Alamouti Code sub-region, a General Stacked Alamouti Code sub-region, a Quasi-Orthogonal Space-Time Block Codes (QOSTBC) sub-region, or an Overlapped Alamouti Code sub-region. Each sub-region of the at least one sub-region may include more than 1 resource unit.

In some embodiments, the second region may comprise at least one of: a 4-resource unit Alamouti Code space-time sub-region with 2 consecutive indexes in a spatial domain and 2 consecutive indexes in the time domain, 4 complex-valued modulation symbols mapped on the 4-resource unit Alamouti Code space-time sub-region according to Alamouti code; a 4-resource unit Alamouti Code space-frequency sub-region with 2 consecutive indexes in the spatial domain and 2 consecutive indexes in the frequency domain, 4 complex-valued modulation symbols mapped on the 4-resource unit Alamouti Code space-frequency sub-region according to the Alamouti code; an 8-resource unit Concatenated Alamouti Code space-time sub-region with 4 consecutive indexes in the spatial domain and 2 consecutive indexes in the time domain, 8 complex-valued modulation symbols mapped on the 8-resource unit Concatenated Alamouti Code space-time sub-region according to Concatenated Alamouti code; or an 8-resource unit Concatenated Alamouti Code space-frequency sub-region with 4 consecutive indexes in the spatial domain and 2 consecutive indexes in the frequency domain, 8 complex-valued modulation symbols mapped on the 8-resource unit Concatenated Alamouti Code space-frequency sub-region according to the Concatenated Alamouti code.

In some embodiments, the communication entity may transmit, to the apparatus, control information for the transmission in one of a radio resource control (RRC) message, a downlink control information (DCI) message, or a media access control (MAC) message.

In some embodiments, the communication entity may transmit, to the apparatus, the control information including configuration related to a 3D resource grid in one of the RRC message, the DCI message, or the MAC message.

In some embodiments, the communication entity may transmit, to the apparatus, the control information including indication related to the N set(s) of time-frequency domain resource(s), and regions and sub-regions of the RxN resource units in one of the RRC message or the MAC message.

In some embodiments, the communication entity may transmit, to the apparatus, the control information including information for receiving the S complex-valued modulation symbols and the mapping in the DCI message or the MAC message.

In some embodiments, the communication entity may transmit, to the apparatus, the control information including indication related to the R DMRS ports as a subset of a set of a first number of antenna ports in at least one of the MAC message or the DCI message.

In some embodiments, each set of time-frequency domain resource may be a resource element in a 2-dimensional (2D) resource grid of a second number of subcarriers in the frequency domain and a third number of OFDM symbols in the time domain.

According to embodiments, an apparatus receives, from a communication entity, S complex-valued modulation symbols of a transmission over RxN resource units on N set(s) of time-frequency domain resource(s) based on a mapping and using R demodulation reference signal (DMRS) ports. R is greater than or equal to 2. N is greater than or equal to 1. RxN is greater than or equal to 3. The mapping includes a first mapping from the S complex-valued modulation symbols to the RxN resource units. S is less than RxN. For s from 1 to S, an s-th complex-valued modulation symbol is mapped to a quantity of r_s resource unit(s), r_s is greater than or equal to 1. For at least one s, r_s is greater than 1. RxN is greater than or equal to 5 if all r_s are equal.

In some embodiments, R and N may be adaptively obtained based on channel condition information and ultra-reliable low latency communications (URLLC) requirements.

In some embodiments, the channel condition information may be obtained based on at least one of a sounding reference signal (SRS) or a channel state information (CSI) report received from the apparatus.

In some embodiments, each DMRS port of the R DMRS ports may correspond to a layer or transmission layer in a spatial domain.

In some embodiments, each resource unit of the RxN resource units may correspond to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in the time domain.

In some embodiments, the R DMRS ports may correspond to a subset of a set of the first number of antenna ports.

In some embodiments, each resource unit of the 3D resource grid may be uniquely identified by (r, k, l), for which r is a first index in the spatial domain, k is a second index in the frequency domain relative to a second reference point, and l is a third index in the time domain relative to a third reference point.

In some embodiments, the 3D resource grid may be defined for a first OFDM numerology including at least one of a subcarrier spacing value or a cyclic prefix value, a first carrier, and a first transmission direction of one of an uplink, downlink, or sidelink direction.

In some embodiments, the RxN resource units may include a first region configured as a spatial multiplexing region. A first complex-valued modulation symbol on the first region may be mapped to only 1 resource unit.

In some embodiments, the mapping may include a second mapping from a first set of one or more of the S complex-valued modulation symbols onto a subset of the resource unit(s) in the first region. A corresponding r_s is 1 for each of the first set of the one or more of the S complex-valued modulation symbols.

In some embodiments, the RxN resource units may include a second region configured as a diversity region. A second complex-valued modulation symbol on the second region may be mapped to more than 1 resource unit.

In some embodiments, the mapping may include a second mapping from a second set of one or more of the S complex-valued modulation symbols onto a subset of the resource unit(s) in the second region. A corresponding r_s is greater than 1 for each of the second set of the one or more of the S complex-valued modulation symbols.

In some embodiments, the mapping may include a second mapping from a second set of one or more of the S complex-valued modulation symbols onto a subset of the resource unit(s) in the second region, using at least one of Alamouti Code, Stacked Alamouti Code, Concatenated Alamouti Code, General Stacked Alamouti Code, Quasi-Orthogonal Space-Time Block Codes (QOSTBC), or Overlapped Alamouti Code.

In some embodiments, the second region may include at least one sub-region, and each of the at least one sub-region is one of an Alamouti Code sub-region, a Stacked Alamouti Code sub-region, a Concatenated Alamouti Code sub-region, a General Stacked Alamouti Code sub-region, a Quasi-Orthogonal Space-Time Block Codes (QOSTBC) sub-region, or an Overlapped Alamouti Code sub-region. Each sub-region of the at least one sub-region may include more than 1 resource unit.

In some embodiments, the second region may comprise at least one of: a 4-resource unit Alamouti Code space-time sub-region with 2 consecutive indexes in a spatial domain and 2 consecutive indexes in the time domain, 4 complex-valued modulation symbols mapped on the—resource unit Alamouti Code space-time sub-region according to Alamouti code; a 4-resource unit Alamouti Code space-frequency sub-region with 2 consecutive indexes in the spatial domain and 2 consecutive indexes in the frequency domain, 4 complex-valued modulation symbols mapped on the 4-resource unit Alamouti Code space-frequency sub-region according to the Alamouti code; an 8-resource unit Concatenated Alamouti Code space-time sub-region with 4 consecutive indexes in the spatial domain and 2 consecutive indexes in the time domain, 8 complex-valued modulation symbols mapped on the 8-resource unit Concatenated Alamouti Code space-time sub-region according to Concatenated Alamouti code; or an 8-resource unit Concatenated Alamouti Code space-frequency sub-region with 4 consecutive indexes in the spatial domain and 2 consecutive indexes in the frequency domain, 8 complex-valued modulation symbols mapped on the 8-resource unit Concatenated Alamouti Code space-frequency sub-region according to the Concatenated Alamouti code.

In some embodiments, the apparatus may receive, from the communication entity, control information for the transmission in one of a radio resource control (RRC) message, a downlink control information (DCI) message, or a media access control (MAC) message.

In some embodiments, the apparatus may receive, from the communication entity, the control information including configuration related to a 3D resource grid in one of the RRC message, the DCI message, or the MAC message.

In some embodiments, the apparatus may receive, from the communication entity, the control information including indication related to the N set(s) of time-frequency domain resource(s), and regions and sub-regions of the RxN resource units in one of the RRC message or the MAC message.

In some embodiments, the apparatus may receive, from the communication entity, the control information including information for receiving the S complex-valued modulation symbols and the mapping in the DCI message or the MAC message.

In some embodiments, the apparatus may receive, from the communication entity, the control information including indication related to the R DMRS ports as a subset of a set of a first number of antenna ports in at least one of the MAC message or the DCI message.

In some embodiments, each set of time-frequency domain resource may be a resource element in a 2-dimensional (2D) resource grid of a second number of subcarriers in the frequency domain and a third number of OFDM symbols in the time domain.

Embodiment techniques solve the technical problems of covariance matrix based communication system for satisfying the low-latency constraint of the URLLC service. Advantages of the disclosed embodiment techniques include meeting the low-latency requirement of the URLLC service and increasing the transmission rates at the same time. The low-latency constraint of the URLLC service may be satisfied by transmission through long term channel information or covariance matrix instead of instantaneous channel information. However, such covariance matrix based communication system would provide a reduced transmission rate for the MIMO URLLC system. To compensate for the rate-gap, embodiment techniques provide joint multiplexing and diversity based transmission schemes to satisfy the low-latency requirement and improve the transmission rates for the MIMO URLLC system.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example wireless communication system, according to embodiments;

FIG. 1B shows a single-user URLLC network with a MIMO base station (BS) communicating with a MIMO user equipment (UE) in the downlink (DL) direction, according to embodiments;

FIG. 1C shows the URLLC transmission over a MIMO channel with many degree of freedoms (DoFs), according to embodiments;

FIG. 1D illustrates a message flow chart between the base station and the UE, according to embodiments;

FIG. 2 shows normalized Eigenvalues in dB for the CDL-A, CDL-B and CDL-C channels considering 16×4 MIMO URLLC system;

FIG. 3 shows rate CDF for the CDL-A channel with precoding based on Long Covariance matrix considering 16×4 MIMO URLLC system, according to embodiments;

FIGS. 4A and 4B show the rate CDF for the CDL-B and CDL-C channels with precoding based on Long Covariance matrix considering 16×4 MIMO URLLC system, according to embodiments;

FIG. 5 illustrates a periodic update strategy of the covariance matrix, according to embodiments;

FIG. 6 shows rate CDF for the CDL-A channel with precoding based on Updated Covariance matrix considering 16×4 MIMO URLLC system, according to embodiments;

FIGS. 7A and 7B show rate CDF for the CDL-B and CDL-C channels with precoding based on Updated Covariance matrix considering 16×4 MIMO URLLC system, according to embodiments;

FIG. 8 shows a hybrid transmission scheme with both long-term and updated covariance matrix, according to embodiments;

FIG. 9 shows rate CDF for the CDL-A channel with precoding based on hybrid transmission scheme, according to embodiments;

FIGS. 10A and 10B show rate CDF for the CDL-A channels for different SNR values considering 16×4 MIMO URLLC system, according to embodiments;

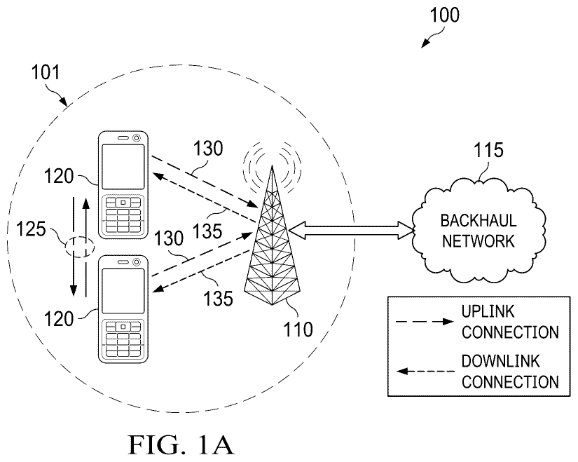

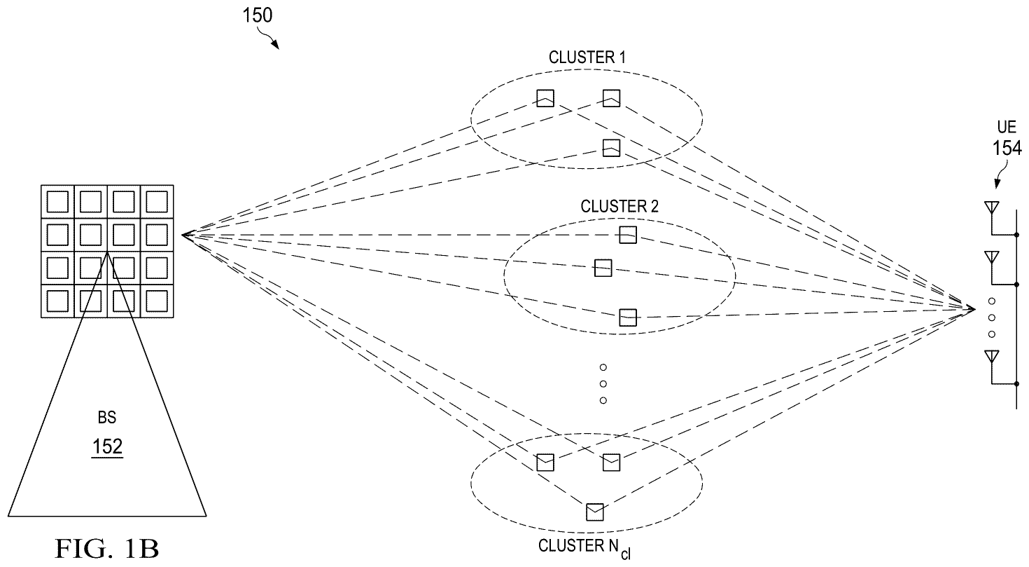

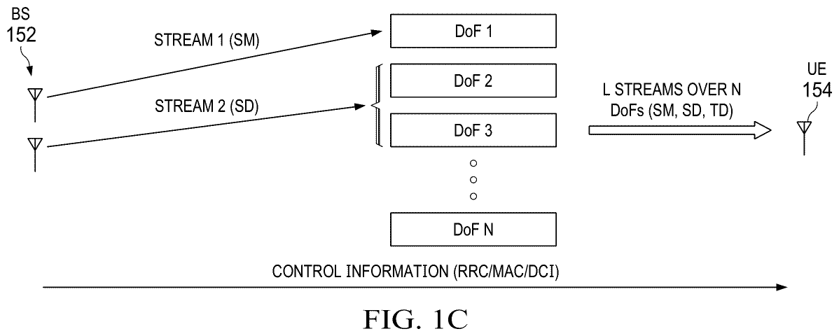

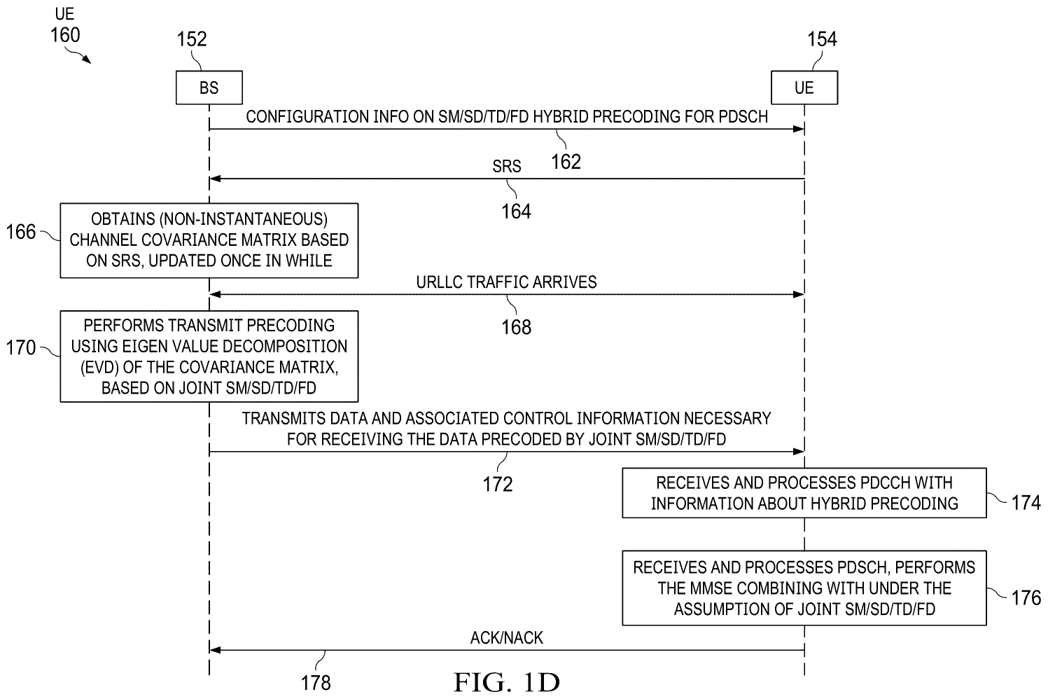

FIG. 1i shows rate CDF for the CDL-A channel with UE speed of 30 km/h considering 16×4 MIMO URLLC system, according to embodiments;

FIG. 12A illustrates a flow chart of a method performed by a communication entity, according to embodiments;

FIG. 12B illustrates a flow chart of a method performed by an apparatus, according to embodiments;

FIG. 12C illustrates a 3D resource grid, according to embodiments;

FIG. 12D illustrates a 3D resource grid of size R×K×L, according to embodiments;

FIG. 12E shows various codes that may be used for precoding, according to embodiments;

FIG. 12F shows mapping of complex-valued modulation symbols to resource units and to physical resource units within the 3D resource grid, according to some embodiments;

FIG. 13 illustrates an example communication system, according to embodiments;

FIGS. 14A and 14B illustrate example devices, according to embodiments; and

FIG. 15 shows a block diagram of a computing system, according to embodiments.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

This disclosure considers a multi-input multi-output (MIMO) ultra-reliable low-latency communication (URLLC) system, where the low-latency constraint of the URLLC service is satisfied by transmission through long term channel information or covariance matrix instead of instantaneous channel information. However, such covariance matrix based communication would provide a reduced rate for the MIMO URLLC system. To compensate for the rate-gap, embodiments in this disclosure provide several diversity oriented transmission schemes combining Spatial Multiplexing, Alamouti Code, and Golden Code. This disclosure also provides an analytical outage rate prediction framework for such joint multiplexing and diversity based transmission schemes. Through extensive simulation using Clustered Delay Line (CDL) channels based on 5G NR specifications, superior lower tail rate performance of the proposed diversity oriented transmission schemes can be achieved.

FIG. 1A illustrates an example communications system 100. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

FIG. 1B shows a single-user MIMO URLLC network 150, according to some embodiments. In FIG. 1B, the MIMO Base Station (BS) 152 is communicating with a M IMO User Equipment (UE) node 154 in the downlink (DL) direction. The BS 152 may incorporate advanced beamforming and transmission techniques to ensure URLLC requirements, while an MMSE RX may be considered at the UE 154. For convenience in analytical description, unless otherwise mentioned, both BS 152 and UE 154 may be assumed to be equipped with Uniform Linear Array (ULA) of N and M antennas, respectively. Furthermore, digital TX and RX beamforming capabilities in both BS 152 and UE 154 may be considered. The simulation results are based on practical dual-polarized antenna configurations.

URLLC has very stringent requirements on latency (e.g., 1 ms) and reliability (10⁻⁵ or even 10⁻⁹). It can be technically difficult to support URLLC with conventional techniques of wireless communications. The network can be equipped with many/massive antennas, which are desirable to be fully utilized for URLLC. However, MIMO is typically considered for eMBB and almost no work is done on MIMO for URLLC.

This disclosure offers technical solutions to utilize the many/massive degrees of freedom (DoFs) provided by MIMO antennas and also frequency/time domains to support URLLC requirements. The conventional systems have their technical challenges. Spatial multiplexing (SM) can increase the rate and shorten the latency. But, with SM, on-demand instantaneous channel state information (CSI) acquisition is challenging, is generally too late for URLLC, and the reliability can be insufficient. Diversity offers high reliability and has lower requirement on on-demand instantaneous CSI acquisition. However, with diversity, the rate is low, and the latency may in turn be too high.

To solve the above technical challenges, embodiments of this disclosure efficiently utilizes the many degrees of freedom (DoFs) offered by MIMO (especially at the base station) to meet the unusually stringent requirements on latency (e.g., 1 ms) and reliability (10⁻⁵ or even 10⁻⁹) of URLLC.

FIG. 1C shows the URLLC transmission over a MIMO channel with many DoFs, according to embodiments. FIG. 1C illustrates an example of covariance-based precoding and minimum mean squared error (MMSE) combining via joint SM, spatial diversity (SD), and time diversity (TD). The base station 152 may obtain (non-instantaneous) channel covariance matrix, updated once in a while. The base station 152 may perform transmit precoding using Eigen Value Decomposition (EVD) of the covariance matrix, based on joint SM, SD, and TD. The base station may then transmit data and associated control information necessary for receiving the data precoded by the joint SM, SD, and TD. On the UE side, the UE 154 may receive the control information and data and performs the MMSE combining under the assumption of the joint SM, SD, and TD. Other types of diversities, such as frequency diversity (FD), may also be combined with the above.

Embodiments provide a technical solution of joint multiplexing and diversity based transmission schemes, combining spatial multiplexing (SM), spatial/temporal/frequency diversity including Alamouti Code, and Golden Code, used in precoding to achieve a good balance between high-rate multiplexing and high-reliability diversity via precoding.

FIG. 1D illustrates a message flow chart 160 between the base station 152 and the UE 154, according to embodiments. At the operation 162, the base station 152 may transmit configuration information on SM/SD/TD/FD hybrid precoding for a physical downlink shared channel (PDSCH) to the UE 154. At the operation 164, the UE 154 may send the SRS to the base station 154. At the operation 166, the base station 152 may obtain the (non-instantaneous) channel covariance matrix based on the SRS. The channel covariance matrix may be updated once in a while. At the operation 168, the URLLC traffic may arrive. At the operation 170, the base station 152 may perform transmit precoding using Eigen Value Decomposition (EVD) of the covariance matrix, based on the joint SM/SD/TD/FD. At the operation 172, the base station 152 may transmit data and associated control information necessary for receiving the data precoded by joint SM/SD/TD/FD to the UE 154. At the operation 174, the UE 154 may receive from the base station 152 and process a physical downlink control channel (PDCCH) with information about the hybrid precoding. At the operation 176, the UE 154 may receive and process the PDSCH from the base station 152 and performs the MMSE combining with under the assumption of the joint SM/SD/TD/FD. At the operation 178, the UE 154 transmits an acknowledgement (ACK) or an NACK to the base station 152 based on the result of the processing of the PDSCH.

### Clustered Channel Model

A DL wireless channel for the MIMO URLLC network 150 can be well approximated by the geometric channel models, which capture the natural spatial channel sparsity. It is assumed that the channel to be composed of N_{CL} spatial path clusters with each cluster containing N_{MPC} multi-path components (MPCs) as shown in FIG. 1B. The clustered channel H(t) ∈ [symbol] ^{M×N} at time slot t can be expressed as

$${H}_{t} {=}^{△} \sqrt{\frac{NM}{{N}_{CL} {N}_{MPC}}} {\sum }_{c = 1}^{{N}_{CL}} {\sum }_{ℓ = 1}^{{N}_{MPC}} {α}_{c , ℓ , t} {a}_{M} ( {θ}_{c , ℓ} ) {a}_{M}^{H} ( {ϕ}_{c , ℓ} ) exp ( j {ω}_{c , ℓ} t ) \qquad ( 1 )$$

where α_{c, l, t} ∈ [symbol] denotes the small scale fading complex gain of the lth MPC in the cth cluster during time slot t ∈ [T], where T is the total number of time slots (snapshots). This small scale fading gain is also time-varying. Here, θ_{c,l} and ϕ_{c,l} represent the Angle-of-Departure (AoD) and Angle-of-Arrival (AoA) of the eth MPC in the cth cluster. The AoDs and AoAs are considered to be constant for T slots. Each ω_{c,l} denotes a Doppler coefficient associated with the lth MPC in the cth cluster and depends on its associated AoA and the velocity vector of the user. For convenience, in (1) a single tap model is shown but the generalization to the multiple tap case is immediate (with each tap modeled analogous to (1)) and the simulations indeed consider the multiple-tap version.

The AoDs and AoAs are associated with the large-scale fading of the DL channel. The coherence time of the time-varying channel corresponding to the small-scale fading parameters is much shorter than that of angular coherence time (the time scale over which the angular profile changes significantly). This implies that there can be significant time-variations of the channel coefficients even in moderate mobility. Typically however, the angular coherence time (also referred to as geometric coherence time) is much larger, and it can take in the order of seconds or more to change significantly relative to the coherence time which is in the order of several milliseconds. As a result, the spatial features of the channel can be assumed to be time-invariant or locally constant (or very slowly time-varying) while the small-scale fading coefficients (complex path gains) are assumed to be varying much faster.

Considering ULA, the steering vector a_{N} (θ) for N antenna elements and any AoD θ is formulated as

$${a}_{N} ( θ ) {=}^{△} {\frac{1}{\sqrt{N}} [ 1 , {e}^{j \frac{2 π}{λ} d sin ( θ )} , … , {e}^{j \frac{2 π}{λ} ( N - 1 ) d sin ( θ )} ]}^{T} , \qquad ( 2 )$$

where λ is the propagation signal wavelength and d (typically chosen as λ/2) denotes the distance between adjacent antenna elements.

### Signal Model

It may be assumed that the BS 152 transmits L≤min(M, N) data streams (e.g., layers or complex-valued modulation symbols) at any time instant to the UE 154. In the baseband, the unit power data symbols collected in symbol vector x ∈ [symbol] ^{L×1}, are processed using the precoder V=[v₁, . . . , v_{L}] ∈ [symbol] ^{N×L}. The received signal vector y ∈ [symbol] ^{M×1} at the UE 154 is expressed as

$$\begin{matrix}y {=}^{△} HVPx + n \\ = H \tilde{x} + n ,\end{matrix} \qquad ( 3 )$$

where P=diag(\sqrt{p₁}, . . . , \sqrt{p_{L}}) and n˜ [symbol] [symbol] (0, σₙ²Iₘ) represent the power allocation matrix and the RX AWGN vector at the UE 154, respectively. The transmitted signal \tilde{x}=VPx is power limited as [symbol] {∥VPx∥²}≤P_{b}. It is to be noted that, for notational simplicity, the time index t is omitted hereafter unless stated otherwise.

The RX signal is processed at the UE node u using a linear (typically MMSE) combiner W=[w₁, . . . , W_{L}] ∈∈ [symbol] ^{M×L} to obtain the estimated symbols as

$$\hat{x} {=}^{△} {W}^{H} y {=}^{△} {W}^{H} HVPx + {W}^{H} n . \qquad ( 4 )$$

An achievable rate for the MMI system is given by

$$\begin{matrix}ℛ {=}^{△} {\sum }_{ℓ = 1}^{L} & {log}_{2} ( 1 + S I N {R}_{ℓ} ) ,\end{matrix} \qquad ( 5 )$$

where SINRₗ represents the lth layer Signal-to-Interference-and-Noise-Ratio (SINR) expressed as

$$S I N {R}_{ℓ} {=}^{△} \frac{{p}_{ℓ} {\vert {w}_{ℓ}^{H} H {v}_{ℓ} \vert}^{2}}{{\sum }_{δ \neq ℓ} {p}_{δ} {\vert {w}_{ℓ}^{H} H {v}_{δ} \vert}^{2} + {σ}_{n}^{2} {\vert {w}_{ℓ} \vert}^{2}} \cdot \qquad ( 6 )$$

### Mimo Precoder and Combiner Design

This section of the disclosure describes designing the precoder and combiner matrices V and W, respectively, to support the ultra-reliable rate of the URLLC applications.

### SVD Precoding and Combiner

The traditional MIMO precoding is performed based on the available DL Channel State Information (CSI) at the BS. In FDD systems the DL CSJ at the BS node can be typically obtained using DL channel estimation along with feedback from the UE, or in TDD systems based on UL channel estimation at the BS and exploiting channel reciprocity. It is noted that even in FDD systems embodiment techniques can exploit partial reciprocity in that several large scale fading parameters can be assumed to be the same over uplink and downlink.

Here, it may be assumed that instantaneous channel is available at the transmitter (this method acts as a benchmark). It has been well-studied and deduced that with the instantaneous channel available at the transmitter the Singular Value Decomposition (SVD) based precoding in the dominant L eigen-modes/right singular vectors of the channel with a water filling power allocation is rate-optimal. With the SVD based precoding, the channel matrix H can be decomposed into H=UAB^{H}, where U and B are unitary matrices containing the singular vectors, and A is a diagonal matrix containing singular values. With this scheme, the transmit precoder and receive combiner can be set as V=B_{(:,1:L)} and W=U_{(:,1:L)}. The optimal rate for the SVD-based precoding is given as follows

$${R}_{SVD} {=}^{△} {\sum }_{ℓ = 1}^{L} {log}_{2} ( 1 + {λ}_{ℓ} {‖ H ‖}^{2} {p}_{ℓ} ) , \qquad ( 7 )$$

where λₗ denotes the squared sorted Eigen values of H and pₗ=

$$max \{ 0 , ( μ - \frac{1}{{λ}_{ℓ} {‖ H ‖}^{2}} ) \}$$

represents the power allocation across lth Eigen mode with μ being the water-filling level such that the Σₗ₌₁^{L} pₗ=P_{b} constraint is satisfied.

### Proposed Covariance Dependent Precoding (Spatial Multiplexing)

Acquisition of the instantaneous CSI at the transmitter (CSIT) is a nontrivial task for multi-antenna systems. In frequency-division duplex (FDD) systems, it may require a feedback loop from the terminals, inducing a significant latency. In time-division duplex (TDD), latency can still be reduced by exploiting channel reciprocity but remains critical. For URLLC it may be preferable to depart from the conventional use of instantaneous CSIT, so the question is how to benefit from the large number of transmit antennas for downlink transmission. One solution includes beamforming based on the multipath structure of the channel, which varies on a coarser time-scale. This structure is distilled into the long-term covariance matrix of the (vectorized) received signal, from which directions of arrival or singular vectors can be determined. Unless otherwise mentioned, this disclosure will use covariance to refer to the long-term covariance wherein the effects of short-term (small scale) fading have been averaged out. This disclosure will use instantaneous or short-term covariance to refer to sample empirical covariance matrix computed using only one snapshot of the channel realization. The latter clearly can be dependent on the short-term fading realization.

This disclosure employs a channel covariance dependent beamforming or spatial multiplexing (SM) approach in contrast to the instantaneous CSI-based approach described above. We assume the channel covariance matrix R_{H}= [symbol] {H^{H}H} is known at the TX of the BS 152. Note that the channel covariance matrix can also be estimated using sample covariance method. It is of particular interest for URLLC applications to estimate the UL channel covariance matrix using F snapshots and utilized the covariance matrix to precode the subsequent URLLC data in the DL based on reciprocity. Therefore, utilizing sample covariance, estimated channel covariance matrix can be written as

$${\hat{R}}_{H} \approx \frac{1}{T} {\sum }_{t = 1}^{T} {H}_{t}^{H} {H}_{t} . \qquad ( 8 )$$

First, this disclosure may perform transmit precoding using Eigen Value Decomposition (EVD) of the channel covariance matrix as \hat{R}_{H}=∪Λ∪^{H}, where U is the unitary matrix of Eigen vectors and A is a diagonal matrix containing the Eigen values in a descending order. Now, we set the precoding matrix as V=U_{(:,1:L)}. Here, power allocation matrix P can be designed to maximize a proxy for the average achievable rate. The combiner is assumed to use the MMSE architecture, where the per-layer combiner is given by wₗ=\sqrt{pₗ}C⁻¹ Hvₗ, where C=Σ_{δ≠l}, p_{δ}|wₗ^{H}Hv_{δ}|²+σₙ²|Wₗ|². An instantaneous rate for the covariance-based precoding approach can be calculated as shown in (5) using which an outage event at any target data rate can be determined.

This disclosure may assume equal power allocation and focus optimization on appropriate choice of the number of Eigenmodes L. This can be viewed as a restricted form of waterfilling over modes and the intuition is that a significant fraction of available gains can be accrued by simply avoiding the wastage of transmit power over relatively weaker Eigenmodes.

### Diversity Oriented Transmission Schemes

For URLLC applications, it may be desired to have covariance-based precoding to satisfy the low-latency as described in the above sections. However, covariance-based precoding and transmission results in a rate-gap at these high required reliability levels compared to the SVD precoding scheme utilizing the instantaneous CSI. Therefore, to satisfy ultra-reliable rate requirement of URLLC systems, embodiment techniques may utilize diversity based transmissions on top of the covariance-based precoding. The insight behind our approach is as follows.

By restricting transmission to be in the subspace spanned by dominant Eigenmodes via covariance based precoding (henceforth referred to as dominant subspace), it ensures that with overwhelming probability the transmission will avoid null-space or suppressed Eigenmodes of the instantaneous channel. Secondly, within this dominant subspace there is still uncertainty about the instantaneous channel. By further employing diversity transmission within the dominant subspace, the embodiment techniques can meet the desired reliability without having to excessively sacrifice transmission rate.

Towards this end, this disclosure may express the equivalent MIMO DL channel \tilde{H} ∈ [symbol] ^{M×L} after precoding and power allocation as

$$\tilde{H} = HVP = [ \begin{matrix}{\tilde{h}}_{1 , 2} & {\tilde{h}}_{1 , 2} & ⋯ & {\tilde{h}}_{1 , L} \\ {\tilde{h}}_{2 , 1} & {\tilde{h}}_{2 , 2} & ⋯ & {\tilde{h}}_{2 , L} \\ ⋮ & ⋮ & ⋱ & ⋮ \\ {\tilde{h}}_{M , 1} & {\tilde{h}}_{M , 2} & ⋯ & {\tilde{h}}_{M , L}\end{matrix} ] . \qquad ( 9 )$$

Now, the embodiment techniques can apply diversity based transmissions considering this equivalent channel in order to improve the rate-reliability of the system.

### Space Time Block Codes (STBC)

Space-Time Block Coding (STBC) has been very successful to achieve full transmit diversity without CSI for improved rate reliability. Therefore, a straightforward extension of the rate-reliability for our transmission schemes is to employ Orthogonal STBC codes after covariance-based beamforming. The most popular OSTBC is the Alamouti code. For two transmit antennas, Alamouti code can be written as below (x* means the complex conjugate of x).

$${X}_{2} = [ \begin{matrix}{x}_{1} & {x}_{2}^{⋆} \\ {x}_{2} & - {x}_{1}^{⋆}\end{matrix} ] . \qquad ( 10 )$$

The basic Alamouti code is orthogonal for basic 2 transmit antenna case. However, there are different STBCs for more than 2 antennas, which trade-off some orthogonality for retaining maximal transmit diversity (such as quasi-orthogonal designs) and can also incur a loss in symbol rate. One goal of this disclosure is to construct STBCs that when used in conjunction with covariance based precoding can achieve improved lower tail rate. These STBCs should preferably also achieve this improved performance when decoded using simpler receivers (such as linear MMSE receivers) and should also span a limited number of channel uses. The latter conditions can ensure that the decoding complexity and latency are kept under control.

Considering X_{L} ∈ [symbol] ^{L×L}^{_{C}} as the appropriate STBC, the received matrix Y ∈ [symbol] ^{M×L}^{_{C}} is expressed as

$$Y = {HVPX}_{L} + N = \tilde{H} {X}_{L} + N , \qquad ( 11 )$$

where L_{C} is length or channel uses of the STBC code. Now the receiver inputs may be vectorized in \tilde{y} ∈ [symbol] ^{ML}^{_{C}}^{×1} and obtain the equivalent channel [symbol] ∈ [symbol] ^{ML}^{_{C}}^{×L} as

$$\overline{y} = H [ \begin{matrix}{x}_{1} \\ {x}_{2} \\ ⋮ \\ {x}_{L}\end{matrix} ] + \overline{n} , \qquad ( 12 )$$

where n̅ represents the vectorized noise vector.

### Stacked Alamouti Code

Stacked Alamouti Code is an extension of basic Alamouti code stacking the code for more than 2 antennas. For L transmit layers, assuming even L, the stacked Alamouti code is expressed as

$${X}_{SAC} = [ \begin{matrix}{x}_{1} & {x}_{2}^{⋆} \\ {x}_{2} & - {x}_{1}^{*} \\ {x}_{3} & {x}_{4}^{*} \\ {x}_{4} & - {x}_{3}^{*} \\ ⋮ & ⋮ \\ {x}_{L - 1} & {x}_{L}^{*} \\ {x}_{L} & - {x}_{L - 1}^{⋆}\end{matrix} ] \qquad ( 13 )$$

Given the Stacked Alamouti code and vectorizing the received signal, the equivalent channel matrix [symbol] ∈ [symbol] ^{2M×L} is obtained as

$$ℋ = [ \begin{matrix}{h}_{1 , 1} & {h}_{1 , 2} & … & {h}_{1 , L} \\ - {h}_{1 , 2}^{*} & {h}_{1 , 1}^{*} & … & {h}_{1 , L - 1}^{*} \\ {h}_{2 , 1} & {h}_{2 , 2} & … & {h}_{2 , L} \\ - {h}_{2 , 2}^{*} & {h}_{2 , 1}^{*} & … & {h}_{2 , L - 1}^{*} \\ ⋮ & ⋮ & ⋱ & ⋮ \\ {h}_{M , 1} & {h}_{M , 2} & … & {h}_{M , L} \\ - {h}_{M , 2}^{*} & {h}_{M , 1}^{*} & … & {h}_{M , L - 1}^{*}\end{matrix} ] \qquad ( 14 )$$

Given the structure of [symbol] , linear MMSE combining vectors for the Stacked Alamouti code can be derived.

### Overlapped Alamouti Code (OAC)

For further reliability improved, Overlapped Alamouti Code (OAC) can be utilized. OAC is motivated by Toeplitz code and overlapping basic Alamouti code, where information symbols and their complex conjugates are linearly embedded to achieve full diversity. For L transmit layers, the stacked Alamouti code is expressed as

$${X}_{OAC} = [ \begin{matrix}{x}_{1} & 0 & {x}_{3} & - {x}_{2}^{*} & … & - {x}_{L - 2}^{*} & 0 & - {x}_{L}^{*} \\ 0 & {x}_{1}^{*} & {x}_{2} & {x}_{3}^{*} & … & {x}_{L - 1}^{*} & {x}_{L} & 0 \\ 0 & - {x}_{2}^{*} & {x}_{1} & - {x}_{4}^{*} & … & - {x}_{L}^{*} & {x}_{L - 1} & 0 \\ {x}_{2} & 0 & {x}_{4} & {x}_{1}^{*} & … & {x}_{L - 3}^{*} & 0 & {x}_{L - 1}^{*}\end{matrix} ] . \qquad ( 15 )$$

The code constructions presented in the following are tailored for the scenario where the dominant subspace has dimension four. In particular the covariance matrix has four dominant Eigenmodes where the strengths of these modes are in decreasing order, i.e., the first Eigenmode is strongest, the second mode is the second strongest and so on.

### Stacked Concatenated Alamouti Code (SCAC)

Here, a variation of the stacked Alamouti code with a specific row permutation may be applied. In particular, for 4 layer transmission we propose the following construction.

$${X}_{2} = [ \begin{matrix}{x}_{1} & {x}_{2}^{*} \\ {x}_{3} & {x}_{4}^{*} \\ {x}_{2} & - {x}_{1}^{*} \\ {x}_{4} & - {x}_{3}^{*}\end{matrix} ] \qquad ( 16 )$$

The equivalent channel in the complex baseband model over two channel uses can be obtained as before. The insight behind this construction is that when the last two layers corresponding to the third and fourth Eigenmodes are suppressed, then this design tends to the SM design with 2 layers which has full rate transmission over the dominant 2 Eigen modes. Indeed, the third and fourth Eigenmodes are used for obtaining additional diversity by spreading transmission over these Eigenmodes. However, there is a tradeoff since a portion of the available total transmit power must also spent towards this spreading, and the relative strength of the Eigenmodes should be used to decide whether additional diversity at the expense of reducing power along dominant Eigenmodes is justified or not. It is worthwhile to note that the original stacked construction will not reduce to full rate SM upon withholding transmission along the weaker Eigenmodes, which prompted us to devise this variation.

### Stacked SM-plus-Alamouti Code

As the name suggests the code constructions in this section comprise of SM codes on top of the Alamouti code. There are the following two constructions. The first one has one layer SM atop the Alamouti code thereby entailing transmission over three Eigenmodes and is given by

$${X}_{2} = [ \begin{matrix}{x}_{1} & {x}_{2}^{*} \\ {x}_{3} & {x}_{4}^{*} \\ {x}_{4} & - {x}_{3}^{*}\end{matrix} ] \qquad ( 17 )$$

The second one has two layer SM atop the Alamouti code thereby entailing transmission over four Eigenmodes and is given by

$${X}_{2} = [ \begin{matrix}{x}_{1} & {x}_{5}^{*} \\ {x}_{2} & {x}_{6}^{*} \\ {x}_{3} & {x}_{4}^{*} \\ {x}_{4} & - {x}_{3}^{*}\end{matrix} ] \qquad ( 18 )$$

Notice that this disclosure has expressed the symbols involved in the SM transmission over the second channel use in their conjugated form. This allows to directly obtain an equivalent channel in the complex baseband model over two channel uses.

### Stacked Golden-Plus-Alamouti Code

First the Golden code is considered. This disclosure considers the following dayal-varanasi variant:

$${X}_{2} = [ \begin{matrix}{\tilde{u}}_{1} & {\tilde{v}}_{1} \\ {\tilde{v}}_{2} & {\tilde{u}}_{2}\end{matrix} ] \qquad ( 19 )$$

where

$$\tilde{u} = {[ {\tilde{u}}_{1} , {\tilde{u}}_{2} ]}^{T} = Mu , \tilde{v} = {[ {\tilde{v}}_{1} , {\tilde{v}}_{2} ]}^{T} = {ϕ}^{\frac{1}{2}}$$

with rotation matrix

$$M = [ \begin{matrix}cos ( θ ) & sin ( θ ) \\ - sin ( θ ) & cos ( θ )\end{matrix} ] \qquad ( 20 )$$

and information symbol vectors u=[μ₁, μ₂]^{T} and v=[v₁, v₂]^{T}. The angles θ, ϕ can be optimized and in particular choosing

$$θ = \frac{1}{2} {tan}^{- 1} ( \frac{1}{2} ) , ϕ = exp ( \frac{j π}{4} )$$

ensures full diversity for any choice of QAM constellations for the information symbols.

Notice that the Golden code also has full rate similar to the SM code for 2 TX antennas. In addition the Golden code guarantees full diversity for optimal (maximum likelihood) receiver. This disclosure considers a stacked extension comprising of a Golden code over an Alamouti code.

This code is well suited for 4 (virtual) TX antennas in which the stronger two Eigenmodes are used as virtual 2 TX for the Golden code since they must bear full rate transmission. On the other hand, the weaker Eigenmodes are used as 2 virtual TX antennas for the Alamouti code since the latter has a reduced rate of 1 symbol per channel use but with full diversity. In the stacked construction, the embodiment techniques use a slightly modified form of the original Golden code, to obtain

$${X}_{2} = [ \begin{matrix}{\tilde{u}}_{1} & {\tilde{v}}_{1}^{*} \\ {\tilde{v}}_{2} & {\tilde{u}}_{2}^{*} \\ {x}_{1} & {x}_{2}^{*} \\ {x}_{2} & - {x}_{1}^{*}\end{matrix} ] \qquad ( 21 )$$

Notice that one useful advantage of the modification in this disclosure is that in this stacked construction, all symbols appear in their conjugated form (upto a sign) in the second channel use. This allows for obtaining an equivalent channel in the complex baseband model on which the structure of this code design is induced. Without such modification, the embodiment techniques may have to consider an equivalent real model entailing larger dimensions.

### Analytical Prediction

For the considered URLLC application, we assume the DL channel with N transmit and M receive antenna as H ∈ [symbol] ^{M×N} where typically for massive MIMO N>>M. Given the channel information, we perform SM precoding using the matrix V ∈ [symbol] ^{N×L} where L denotes the number of layers such that M≥L.

From (12), after appropriate SM and STBC precoding the complex baseband model of the received signal can be written as

$$\overline{y} = ℋ x + n \qquad ( 22 )$$

In this complex baseband model the vector x is the vector of symbols and the matrix [symbol] is the equivalent matrix on which the structure of the employed inner code has been induced. The vector n is the vector of noise random variables which are i.i.d. Consider next the equivalent real model obtained from the complex baseband model:

$$■ ( {y}^{∼} \& = [ ■ ( Re ( \overline{y} ) @ Im ( \overline{y} ) ) ] = [ ■ ( Re ( ℋ ) \& - Im ( H ) @ Im ( H \& Re ( H ) ) ] [ ■ ( Re ( x ) @ Im ( x ) ) ] + [ ■ ( Re ( n ) @ Im ( n ) ) ] @ \& = {ℋ}^{∼} {x}^{∼} + {n}^{∼} ) \qquad ( 23 )$$

Let [symbol] ₁, denote the latest (most-recent) estimate of the equivalent real channel that is available at the transmitter. At the target slot the receiver is assumed to know the perfect equivalent channel [symbol] . The transmitter needs to predict an analytical rate that can be achieved in the target slot using the available most recent estimate at hand. Consider the error or mismatch between the true channel at the receiver at the current (or target) slot and the most recent available estimate of the equivalent real channel. The embodiment techniques begin by expanding the current equivalent channel as

$$\tilde{ℋ} = {\tilde{ℋ}}_{1} + \tilde{ε} \qquad ( 24 )$$

Recall that \tilde{η} ∈ [symbol] ^{2M}^{_{C}}^{×2L} is the equivalent real channel that has the structure induced by the inner code and the SM technique. Here M_{C}≥M denotes the number of effective receive dimensions upon accounting for the fact that depending on the employed inner code, received observations over multiple channel uses might need to be collected. Analogous comment applies to the available estimate matrix [symbol] ₁ which has the same structure as in [symbol] . The matrix \tilde{ε} is referred to here as the error or uncertainty matrix and we remark that it also possesses the same structure that is present in [symbol] , [symbol] ₁.

One technical problem is to find the worst case achievable sum rate without knowing the specific error matrix. Without any constraints on \tilde{ε} this worst-case rate will be zero. Therefore, the challenge is to impose or confine \tilde{ε} to as small a region as possible while ensuring that this region includes error matrices {\tilde{ε}} that, when added to the available estimate matrix includes a highly probable set of realizable true equivalent channel matrices. This disclosure will discuss this aspect further in the sequel. It is noted here that embodiment techniques can exploit the approach pursued in [1] but directly adopting that approach will ignore the structure induced by the inner code used by the transmission scheme, and thereby yield excessively pessimistic predicted rates. On the other hand, it is not apparent if the analysis in [1] can be extended to address the presence of inner codes. This disclosure device a technique that allows for exploiting the induced structure in the analysis.

The problem of interest may be written as

$$\frac{1}{2} {min}_{\begin{matrix}\tilde{ε} : \\ {‖ f ( \tilde{ε} ) ‖}_{F}^{2} \leq δ\end{matrix}} {\sum }_{i = 1}^{2 L} {ℛ}_{i} \qquad ( 25 )$$

$$where$$

$${ℛ}_{i} = log ( \frac{1 + {‖ {\tilde{w}}_{i}^{T} {\tilde{ℋ}}_{( : , i )} ‖}^{2}}{{σ}^{2} {‖ {\tilde{w}}_{i} ‖}^{2} + {\sum }_{\begin{matrix}j = 1 \\ i \neq j\end{matrix}}^{2 L} {‖ {\tilde{w}}_{i}^{T} {\tilde{ℋ}}_{( : , j )} ‖}^{2}} ) \qquad ( 26 )$$

and [symbol] _{(:,j)} denotes the j^{th} column of [symbol] . The ½ fraction is due to the real model and for convenience, this disclosure will drop this in the sequel. Further, the equivalent real model of the MMSE BF is defined as \tilde{W}=[\tilde{w}₁ \tilde{w}₂ . . . , \tilde{w}_{2L}].

Utilizing the relation between the Shannon rate and minimum mean squared error (MMSE), cf. [2], the rate for each layer in the real-model can be written as

$$\begin{matrix}{ℛ}_{i} = log ( \frac{1}{{\hat{e}}_{i}} ) \\ = {max}_{{s}_{i}} \{ log ( {s}_{i} ) - {\hat{e}}_{i} {s}_{i} + 1 \} \\ = {max}_{{s}_{i} , {\tilde{w}}_{i}} \{ log ( {s}_{i} ) - {\hat{e}}_{i} ( {\tilde{w}}_{i} ) {s}_{i} + 1 \}\end{matrix}$$

e above equations, with some abuse of notation, this disclosure has let êᵢ denote the MMSE while this disclosure lets êᵢ (\tilde{w}ᵢ) denote the MSE achieved using filter (beamforming vector) \tilde{w}ᵢ. Notice also that since the MSE is always non-negative, the maximizing sᵢ will always be non-negative, and hence this disclosure can restrict the search space of each sᵢ to be the set of non-negative real numbers. Consequently, the worst case sum rate can be written as

$$( min ) ⊤ ■ ( \tilde{ε} \_ : @ ‖ f ( \tilde{ε} ) ‖ \_F ⋀ 2 \leq δ ) ( max ) ⊤ ( s\_i , \tilde{w} \_i ) \{ Σ\_ ( i = 1 ) ⋀ \qquad ( 28 )$$

$$2 L log ( s\_i ) ⊣ r ( ( \tilde{W ⋀} T \tilde{H} - I ) ( \tilde{W ⋀} T \tilde{H} - I ) ⋀ TD ) -$$

$$Tr ( \tilde{W ⋀} T \tilde{W} D ) + 2 L \}$$

where D=diag(s₁, s₂, . . . , s_{2L}).

Next, a lower bound on this achievable rate (and hence itself achievable) can be obtained by replacing min-max with max-min and can written as

$$\begin{matrix}{max}_{{s}_{i} , {\tilde{w}}_{i}} {min}_{{{\tilde{ε}}_{i}}_{{‖ f ( \tilde{ℰ} ) ‖}_{F}^{2} \leq δ}} \{ \begin{matrix}{Σ}_{i = 1}^{2 L} & log (\end{matrix} {s}_{i} ) - Tr ( ( {\tilde{W}}^{T} \tilde{ℋ} - I ) {( {\tilde{W}}^{T} \tilde{ℋ} - I )}^{T} D ) - Tr ( {\tilde{W}}^{T} \tilde{W} D ) + 2 L \} \\ ⇔ {max}_{{s}_{i} , {\tilde{w}}_{i}} {min}_{{\tilde{ε} :}_{{‖ f ( \tilde{ℰ} ) ‖}_{F}^{2} \leq δ}} \{ 2 log \vert B \vert - Tr ( ( {\tilde{W}}^{T} \tilde{ℋ} - I ) {( {\tilde{W}}^{T} \tilde{ℋ} - I )}^{T} {BB}^{T} ) - Tr ( {B}^{T} {\tilde{W}}^{T} \tilde{W} B ) + 2 L \}\end{matrix}$$

$$D = {BB}^{T} and B = dia g ( \sqrt{{s}_{1} ,} \sqrt{{s}_{2} ,} ⋯ , \sqrt{{s}_{2 L}} )$$

ization problem is considered.

$${min}_{{\tilde{ε} :}_{{‖ f ( \tilde{ℰ} ) ‖}_{F}^{2} \leq δ}} \{ - Tr ( ( {\tilde{W}}^{T} \tilde{ℋ} - I ) {( {\tilde{W}}^{T} \tilde{ℋ} - I )}^{T} {BB}^{T} ) \}$$

This can be shown to be equivalent to

$$\begin{matrix}{max}_{τ} \{ - τ \} \\ s . t . ‖ {B}^{T} {\tilde{W}}^{T} ( {\tilde{ℋ}}_{1} + \tilde{ε} ) {‖}_{F}^{2} \leq τ , ∀ \tilde{ε} : {‖ f ( \tilde{ε} ) ‖}_{F}^{2} \leq {δ}^{1 )}\end{matrix}$$

To further simplify, this disclosure may define z=vec(B^{T}\tilde{W}^{T} [symbol] ₁). Further, this disclosure may define the vector of free (independent) variables in the matrix \tilde{ε} by the vector of \ddot{μ}. This disclosure introduces an observation which allows for developing the analysis in this disclosure.

The entries in the error matrix \tilde{ε} are all linear in the free variables, i.e., in the elements of the vector \hat{μ}. As a result, this disclosure may express

$$vec ( {B}^{T} {\tilde{W}}^{T} \tilde{ε} ) = A \tilde{μ} . \qquad ( 32 )$$

Using this observation, it becomes possible to express the problem of interest as

$$\begin{matrix}{max}_{τ} \{ - τ \} \\ s . t . \text{‖} z + A \tilde{μ} {‖}_{F}^{2} \leq τ , ∀ \hat{μ} : {‖ \hat{μ} ‖}_{F}^{2} \leq δ\end{matrix}$$

Using classical S-lemma techniques, [3], it can be shown that

$$\text{‖} z + A \hat{μ} {‖}_{F}^{2} \leq τ , ∀ \hat{μ} : {‖ \hat{μ} ‖}_{F}^{2} \leq \qquad ( 34 )$$

$$δ ⇔ [ \begin{matrix}τ - λ & {z}^{T} & 0 \\ z & I & - δ A \\ 0 & - δ {A}^{T} & λ I\end{matrix} ] ≽ 0 , for some λ \geq 0$$

Finally, recalling that without loss of generality each sᵢ can be restricted as sᵢ≥o, the overall problem may be written as

$$\begin{matrix}{max}_{\{ {s}_{i} \geq 0 , {\tilde{w}}_{i} \}} {max}_{τ , λ \geq 0} \{ 2 log \vert B \vert - τ - T r ( {B}^{T} {\tilde{W}}^{T} \tilde{W} B ) + 2 L \} \\ s . t . [ \begin{matrix}τ - λ & {z}^{T} & 0 \\ z & I & - δ A \\ 0 & - δ {A}^{T} & λ I\end{matrix} ] ≽ 0 ( B ⋀ T \tilde{W ⋀} T \tilde{ℋ} \_ 1 ) and A =\end{matrix}$$

((I ⊗ B\hat{ }T W\hat{ }T)). Here, this disclosure has used <. > to denote the operations that need to be done on the matrix argument I ⊗ B^{T}\tilde{W}^{T} to ensure that vec(B^{T}\tilde{W}^{T}ε)=A\tilde{μ}.

This disclosure may utilize alternating optimization technique to solve the overall optimization problem in an alternating fashion, with each of the two steps considering a subset of variables. In particular, in one step the subset of variables is {{\tilde{W}ᵢ}, λ, τ}, whereas in the second step the optimization is over the subset {λ, τ, {sᵢ}}. In each of the steps, the variables not in the considered subset are held fixed to their most recent updated values. The overall algorithm is detailed in Algorithm 1 shown below.

Algorithm 1: MIMO URLLC Worst case rate prediction
Input: Equivalent complex baseband channel of slot with the most-recent estimate, [symbol] ₁,
and error norm for the target slot δ.
Output: Worst case rate of target slot [symbol] = Σ_{i=L}^{2L} [symbol] ᵢ.
$1 : Obtain equivalent real effective channel {\tilde{ℋ}}_{1} = [ \begin{matrix}Re ( {ℋ}_{1} ) & - Im ( {ℋ}_{1} ) \\ Im ( {ℋ}_{1} ) & Re ( {ℋ}_{1} )\end{matrix} ] ,$
2: Set initial MMSE filter \tilde{W} = ( [symbol] ₁ [symbol] ₁^{T} + I_{2N})⁻¹ [symbol] ₁.
3: repeat
4: Find \hat{B} by maximizing the following problem
${arg max}_{B ≽ 0 \& diagonal , τ , λ \geq 0} \{ 2 log \vert B \vert - τ - Tr ( {B}^{T} {\tilde{W}}^{T} \tilde{W} B ) + 2 L \}$

| | |
|---|---|
| $s . t . [ \begin{matrix}τ - λ & {z}^{T} & 0 \\ z & I & - δ A \\ 0 & - δ {A}^{T} & λ I\end{matrix} ] ≽ 0 ,$ | where z = vec(B^{T}\tilde{W}^{T} [symbol] ₁ − |

B^{T}) and A = [symbol] (I ⊗ B^{T}\tilde{W}^{T}) [symbol] .
5: Update B → \hat{B}.
6: Find [symbol] by solving the following maximization problem
where z = vec(B^{T}\tilde{W}^{T} [symbol] ₁ − B^{T}) and A = [symbol] (1 ⊗ B^{T}\tilde{W}^{T}) [symbol] .
7: Update \tilde{W} → [symbol] .
8: until Convergence

Note that convergence is guaranteed since the objective function (which is bounded above) monotonically improves in each step. Also each optimization is a max-log-det problem subject to linear matrix inequality constraints and hence can be efficiently solved. This disclosure employs open source CVX solver for this purpose.

This disclosure now considers imposing tighter constraints on the set of error matrices in order to obtain tighter worst-case achievable rate predictions. Towards this end, we first summarize our overall approach as follows:
A bounded region in which the errors (predominantly) lie is selected.
The bounded region may be described by quadratic form.
For Gaussian distributed errors, such region can be linked to desired reliability (outage) level.
Then, for each candidate transmission scheme (choice of inner code), the worst-case rate over errors in that bounded region can be found.
Then, the transmission scheme with the best (or highest) worst-case rate can be chosen.

Next, this disclosure discusses different choices for the bounded region of error vectors \hat{μ} recall that elements of this vector are the free variables in the structured error matrix \tilde{ε} and that each entry of the latter matrix is a linear combination of the elements of \hat{μ}.
The basic region is a spherical one which this disclosure has hitherto used, i.e.,

$$\{ \hat{μ} : ‖ \hat{μ} {‖}^{2} \leq δ \} ,$$

for some appropriate choice of δ. One choice of S can be the minimal choice that can ensure each one of a large set of generated error vectors has a squared norm no greater than δ. Therefore, it can be the largest squared norm over the set of generated error vectors.
The next one is suitable for the scenario where each \hat{μ} is considered to be the realization of a Gaussian random vector which is zero-mean and has a known covariance matrix A.

In this case, this disclosure can use the region defined as

$$\{ \hat{μ} : {\hat{μ}}^{T} {A}^{- 1} \hat{μ} \leq δ \} ,$$

Here, the choice of δ can be tailored to achieve the desired level of reliability.

Another approach is to consider minimum volume enclosing ellipsoid (MVEE). In particular, suppose that a large set of realizations of \hat{μ}, denoted by {\hat{μ}ₗ}ₗ₌₁^{J} are available. Here, the desired ellipsoid may be obtained by solving the following optimization problem:

$$\begin{matrix}{max}_{c , Q ≽ 0} \{ - log \vert Q \vert \} \\ s . t . {( {\hat{μ}}_{ℓ} - c )}^{T} Q ( {\hat{μ}}_{ℓ} - c ) \leq 1 ∀ ℓ\end{matrix}$$

imization problem fortunately has efficient solutions such as those based on Khachiyan's algorithm. Using the obtained ĉ, \hat{Q}, this disclosure may define the region of interest as

$$\{ \hat{μ} : {( \hat{μ} - \hat{c} )}^{T} \hat{Q} ( \hat{μ} - \hat{c} ) \leq 1 \}$$

Furthermore, this disclosure may also immediately extend the analysis to incorporate error vectors in this region. Indeed, this disclosure can define a transformed vector of free variables as

$$\tilde{μ} = {\hat{Q}}^{\frac{1}{2}} ( \hat{μ} - \hat{c} )$$

so that the region of interest becomes {\tilde{μ}: ∥\tilde{μ}∥²≤1}. Considering, the remaining steps of the analysis, it is only needed to update z→z+Aĉ followed by

$$A \to A {Q}^{- \frac{1}{2}} .$$

In another variation, this disclosure can consider solving the following optimization problem

$$\begin{matrix}{max}_{c , Q ≽ 0} \{ {θ}_{min ( Q )} \} \\ s . t . {( {\hat{μ}}_{ℓ} - c )}^{T} Q ( {\hat{μ}}_{ℓ} - c ) \leq 1 ∀ ℓ\end{matrix}$$

in (Q) denotes the minimal Eigen-value of Q. The obtained c, Q can be used to define the region of interest and extend the analysis exactly as in the previous case.
simulation RESULTS

In this section, this disclosure presents extensive simulation results for considered beamforming approaches for MIMO URLLC systems.

This disclosure has considered the MIMO URLLC network with N=16 TX antennas at the gNB or BS and M=4 RX antennas at the UE, a special configuration of the single-user MIMO system shown in FIG. 1B. Simulation of the Clustered Delay Line (CDL) models is based on the 5G NR specifications as provided in 3GPP TR 38.901. The CDL models are defined for the full frequency range from 0.5 GHz to 100 GHz with a maximum bandwidth of 2 GHz. Specifically, we have considered CDL-A, CDL-B and CDL-C channel models, which represent three different channel profiles for NLOS. The channels are simulated for 5×10⁵ slots amounting to 0.5 ms duration. The UE is considered to be moving in a constant velocity of 3 km/h unless stated otherwise.

### Eigenvalues of the CDL Channels

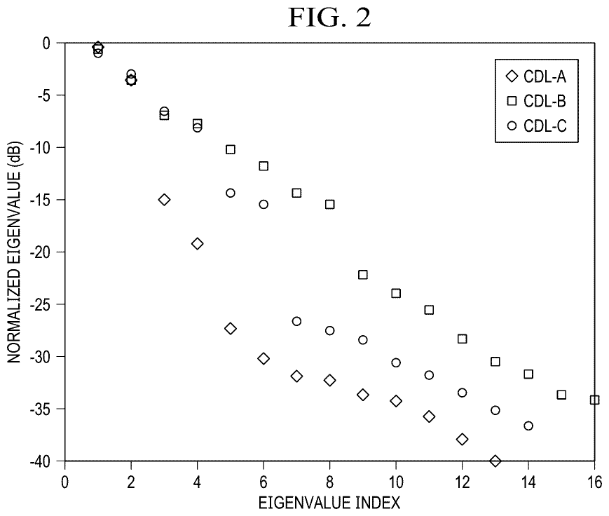

First, this disclosure investigates the eigenvalue distribution of covariance matrix induced by the considered CDL-A, CDL-B and CDL-C channel models. FIG. 2 plots the normalized eigenvalues of the CDL-A. CDL-B, and CDL-C channels for the considered 16×4 MIMO system. It is evident from FIG. 2 that the CDL-A channel has two strongest eigenvalues, while the remaining eigenvalues are all much weaker. For CDL-B and CDL-C channels, the eigenvalue powers among the top 4 eigenvalues reduces less sharply. As maximum 4 layers (L≤4) can be transmitted, since the RX has 4I antennas, this disclosure may employ previously mentioned Stacked Concatenated Alamouti Code, different number of SM layers in Stacked SM-plus-Alamouti Code, and Stacked Golden-plus-Alamouti Code. One objective is to achieve with high reliability a larger DL rate that can potentially be provided by the diversity oriented transmission schemes when used along with covariance based precoding.

### Diversity Oriented Schemes for Upto 4 Layers

Table 1, presents the possible diversity oriented transmission schemes for upto L=4 layers based on our considered code constructions in the previous sections. The different schemes make use of the different SM-plus-Alamouti or Golden code plus Alamouti based precoding and transmission to achieve the desired symbol rate and diversity. In this table the rate refers to the effective number of symbols transmitted per channel use whereas the rank refers to the number of dominant Eigenmodes that are used by the transmission scheme. A rank [symbol] scheme will entail transmission over the top [symbol] eigenmodes.

| | Rank 1 | Rank 2 | Rank 3 | Rank 4 |
|---|---|---|---|---|
| Rate 4 | | | | SM |
| | | | | 4 Layers |
| Rate 3 | | | SM + SD | SM + AM/ |
| | | | 3 Layers | GC + AM |
| | | | | 2 + 2 Layers |
| Rate 2 | | SM + SD | SM + AM | Stacked Concat. |
| | | 2 Layers | 1 + 2 Layers | AM |
| | | | | 4 Layers |
| Rate 1 | SD | Alamouti | | QOSTBC |
| | 1 Layer | 2 Layers | | 4 Layers |

### Table 1: Diversity Schemes for Upto Rank (Layer) 4 Transmission

Rate CDF with Long-Term Covariance Matrix

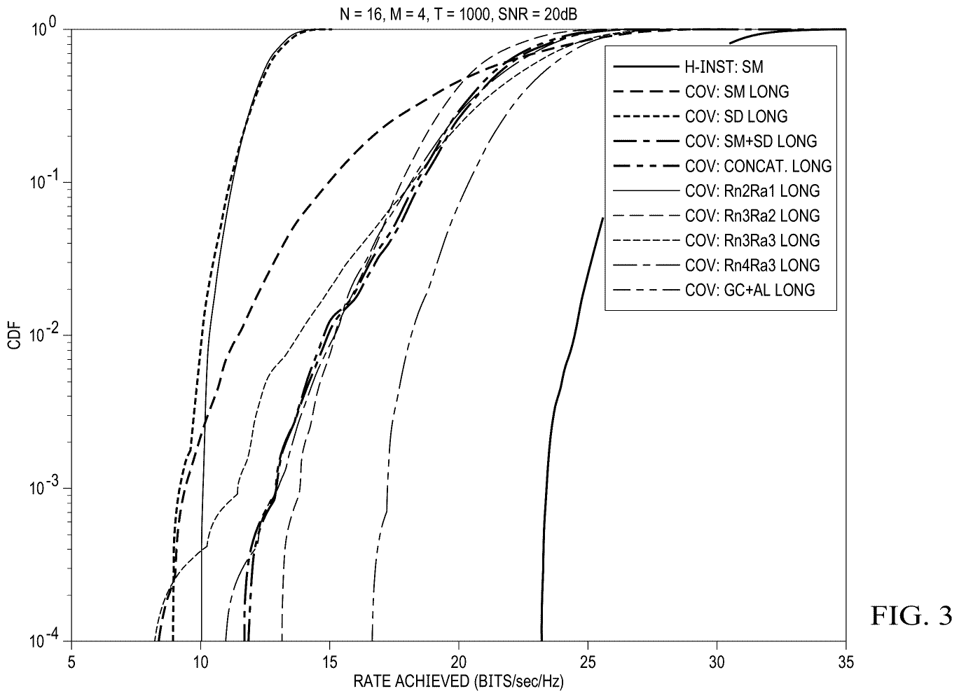

FIG. 3 plots the rate CDF achieved using the transmission schemes in Table 1 for CDL-A channel with an SNR of 20 dB. The precoding matrix V is derived based on the long-term covariance matrix R_{H}, which is calculated using the sample covariance matrix computed over all the slots. It is evident from the figure that the diversity oriented transmission schemes provide a much higher reliable rate than basic Spatial Multiplexing with 4 layers. Specifically, the GC+AL transmission schemes provides the best rate at 10⁻⁴ reliability. FIG. 3 also plots the rate CDF for transmission with instantaneous channel for comparison. Although the proposed diversity oriented schemes provide better reliable rate than basic SM technique, there is still a significant rate gap in comparison with the reliable rate achieved via instantaneous CSI. As shown in FIG. 3, the hybrid scheme performs the best.

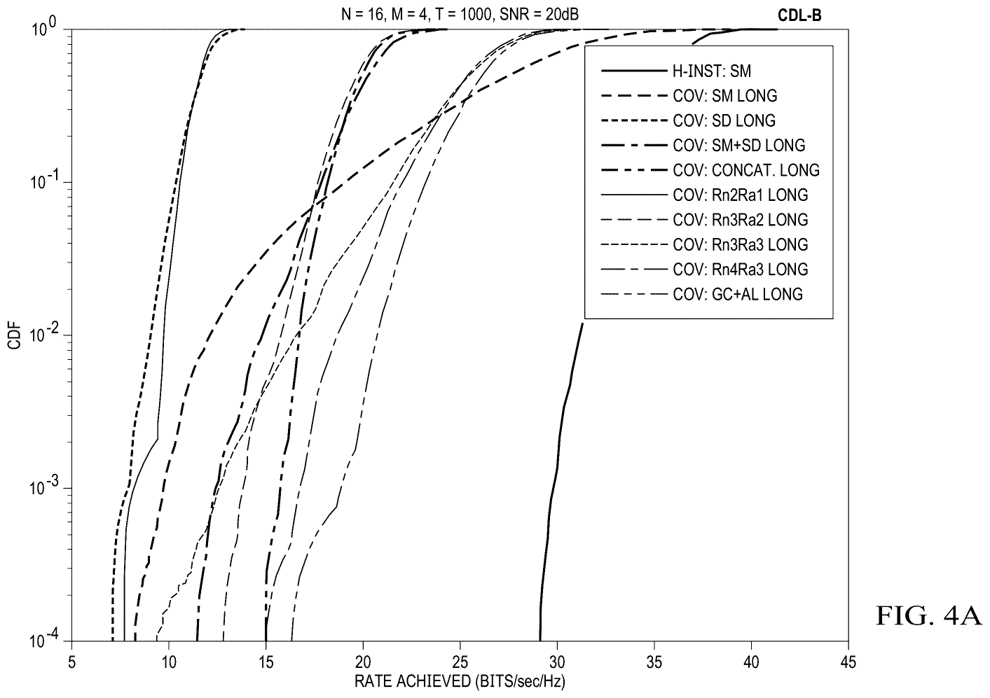

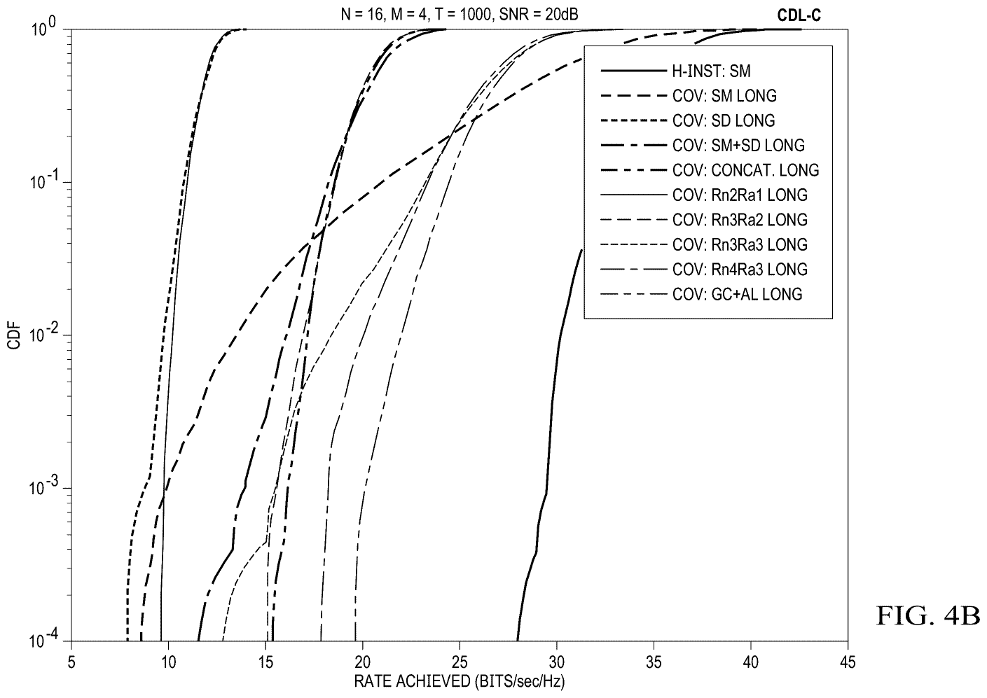

FIGS. 4A and 4B show the rate CDF achieved using the transmission schemes in Table 1 for CDL-B and CDL-C channels with an SNR of 20 dB. The same trend is observed as CDL-A channel model, however the rate-gap to the instantaneous CSI rate is even larger for these channels.s

### Covariance Matrix Update

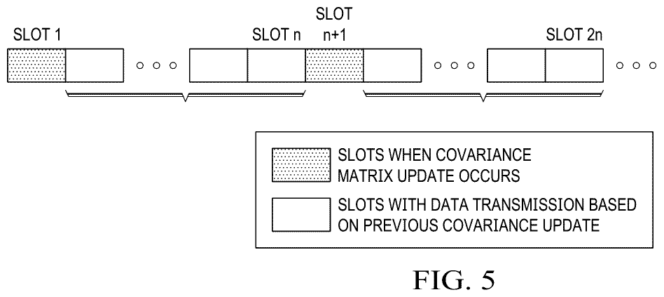

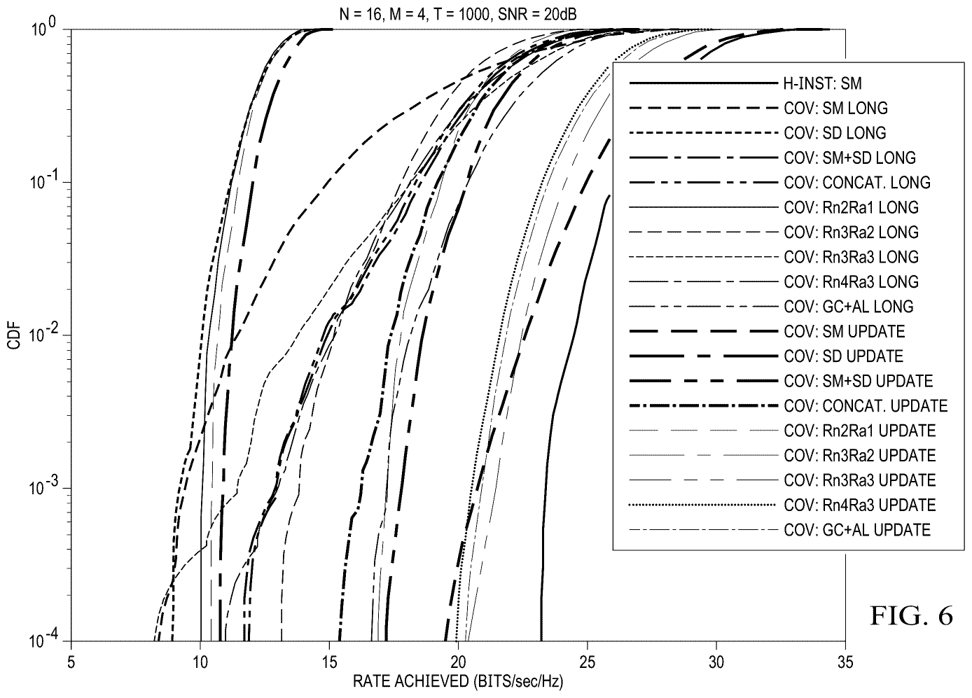

To reduce the rate gap between precoding based on long-term covariance matrix followed by diversity transmission, and precoding based on instantaneous CSI, this disclosure provides a periodic date strategy for the channel covariance matrix. As shown in FIG. 5, the embodiment techniques may update the covariance matrix in every n slots. A basic update (which unless otherwise mentioned we adopt for simplicity) is to reset the covariance to the instantaneous covariance computed in each slot during which instantaneous CSI is received.

Rate CDF with Covariance Matrix Update

FIG. 6 plots the rate CDF of transmission schemes in Table 1 for CDL-A channel with an SNR of 20 dB, where the SM precoding is performed using updated covariance matrix. This disclosure may consider updating the covariance matrix with instantaneous channel state information received once in every 50 slots. As shown in the figure, the updated covariance matrix strategy reduces the rate gap compared to the instantaneous CSI based channel rate for diversity oriented transmission schemes. Especially the GC+AL and Rn4Ra3 schemes from Table 1 perform competitively.

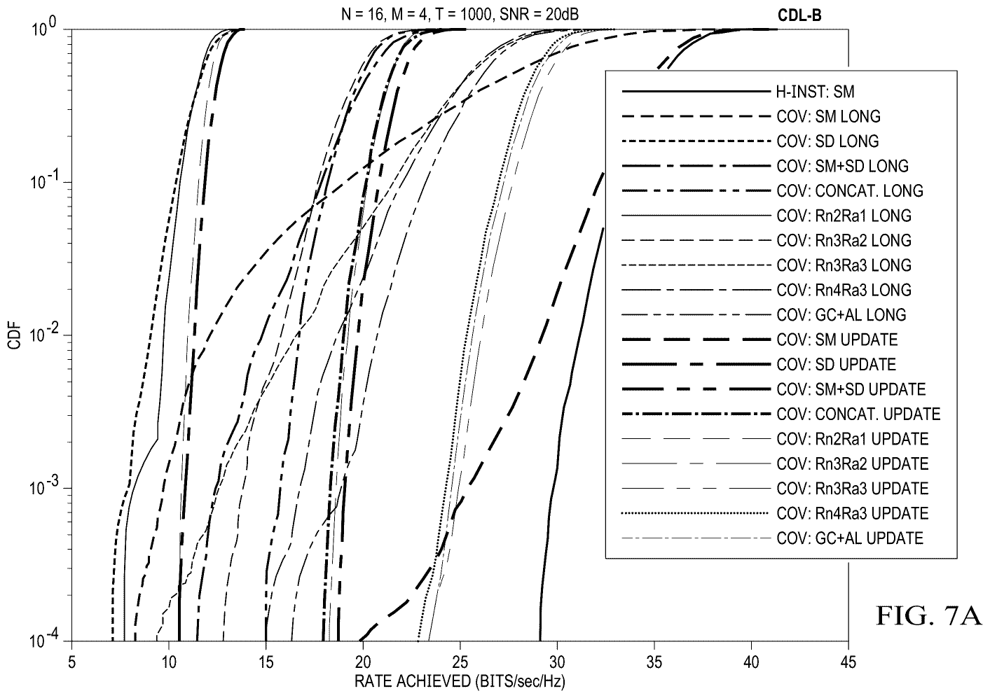

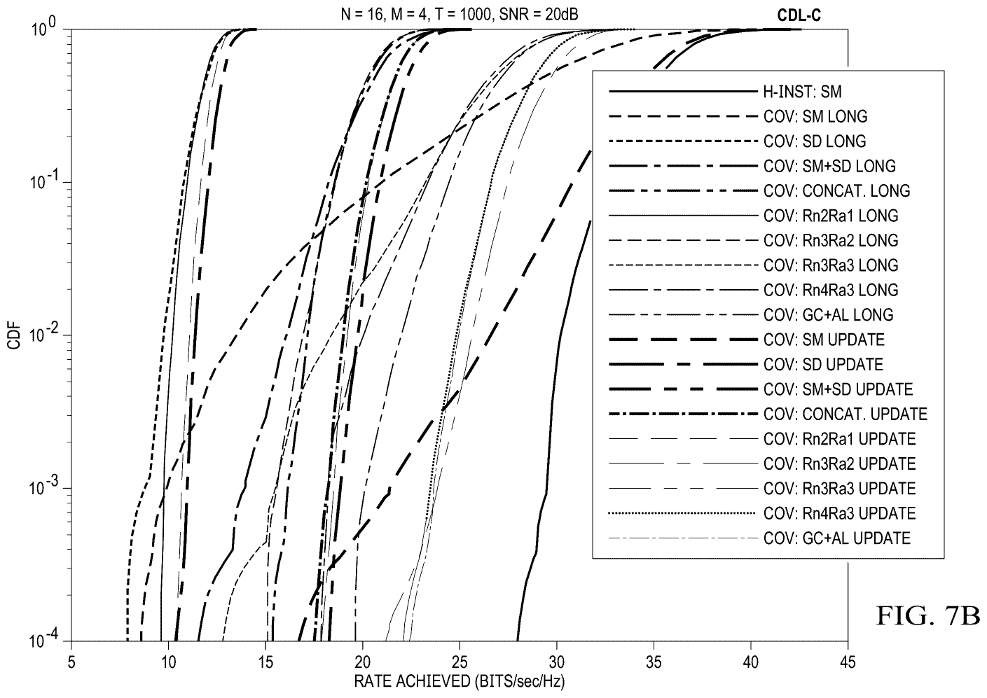

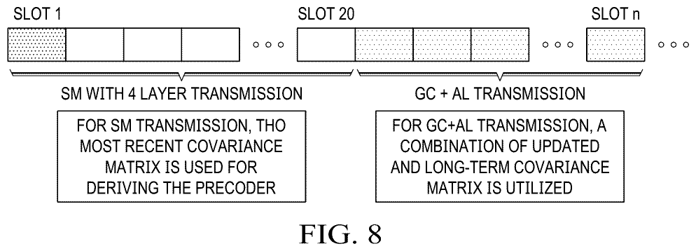

FIGS. 7A and 7B show the rate CDF achieved using the transmission schemes in Table 1 for CDL-B and CDL-C channels with an SNR of 20 dB. The same trend is observed as (CDL-A channel model, however the rate-gap to the instantaneous CSI rate has been further reduced compared to the gap observed when relying only on long-term covariance matrix.

### Hybrid Transmission Scheme

This disclosure uses the observation that since the covariance matrix is updated in every 50 slots, the long-term covariance matrix information can be used for the last few (for instance last tens of) slots before the next update, while only the initial slots may use the updated covariance matrix. This insight comes from the fact that in the slots immediately following the update the CSI obtained in the update slot is highly correlated with the true CSI in those slots. Then, invoking the result that precoding is optimal when perfect CSI is available at the transmitter, the embodiment techniques may choose only to rely on precoding based on most-recent CSI without any diversity scheme. For the slots in which we exploit long-term covariance, GC+AL transmission scheme may be used, which has been verified to be one of the most effective diversity providing technique. For these slots the most recent CSI is outdated and using long-term covariance in conjunction with diversity transmission is well justified explained above.

FIG. 8 depicts the embodiment hybrid transmission scheme strategy using both long-term and updated covariance matrix.

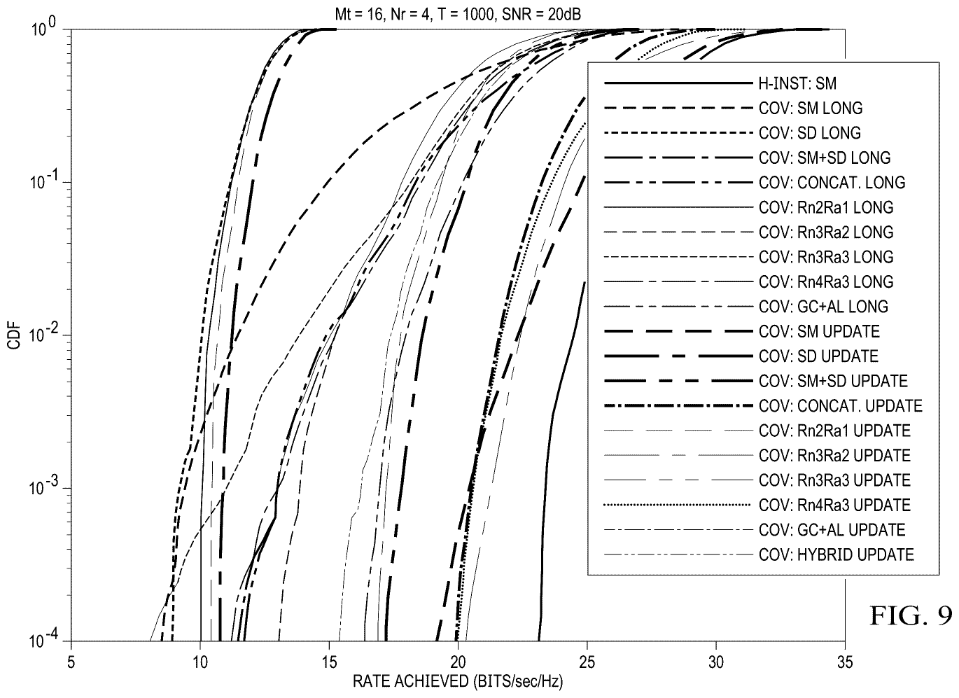

FIG. 9 plots the rate CDF of the hybrid transmission scheme using both long-term and updated covariance matrix for CDL-A channel with an SNR of 20 dB.

Rate CDF with Different SNR

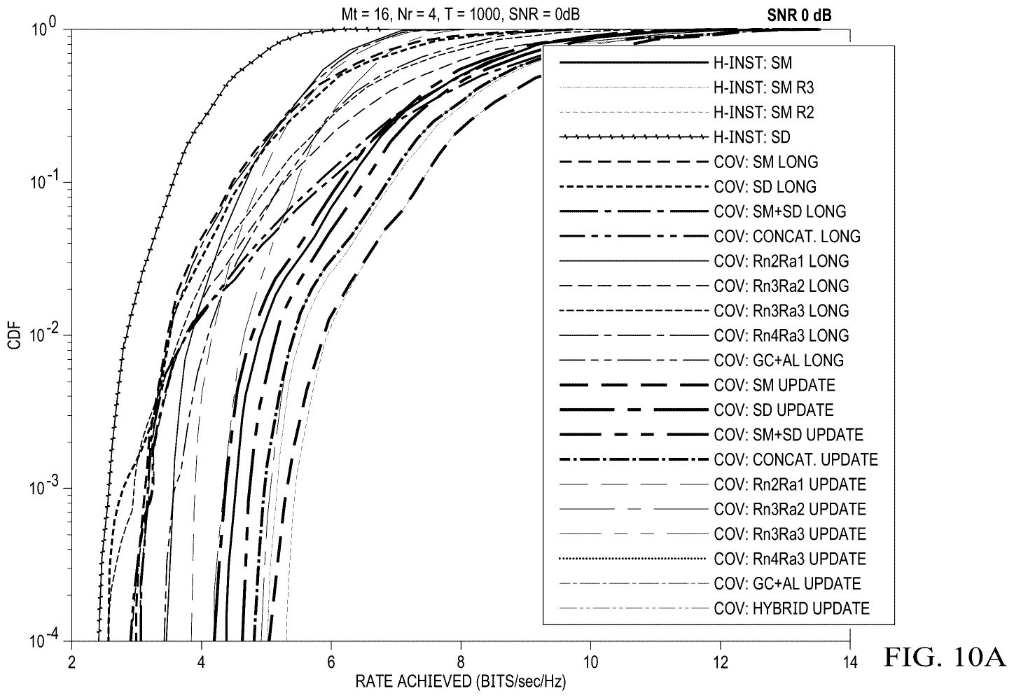

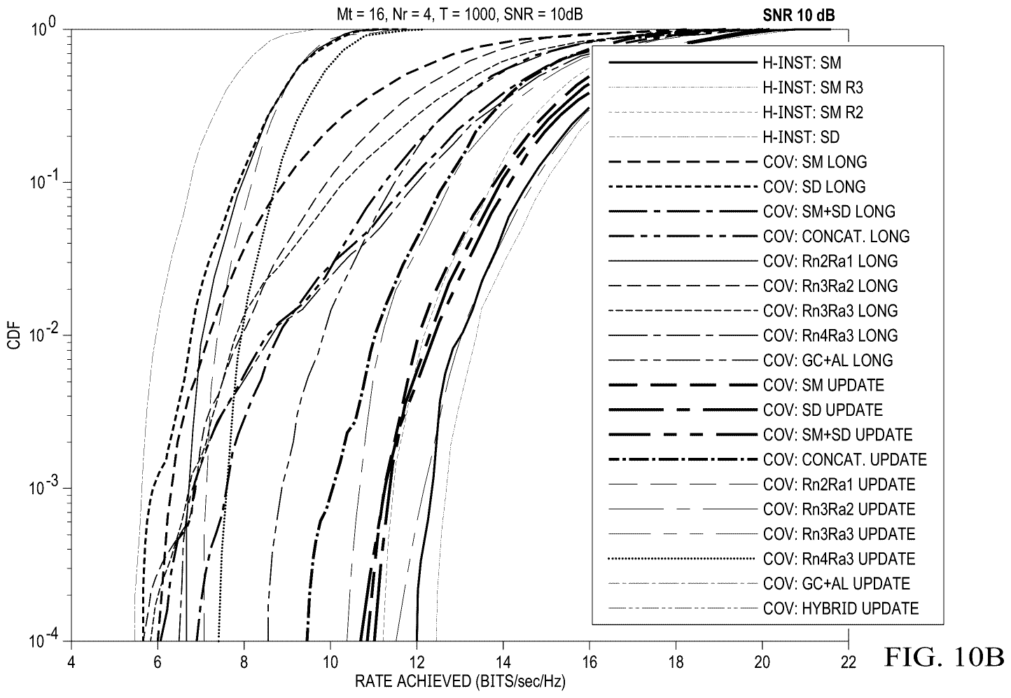

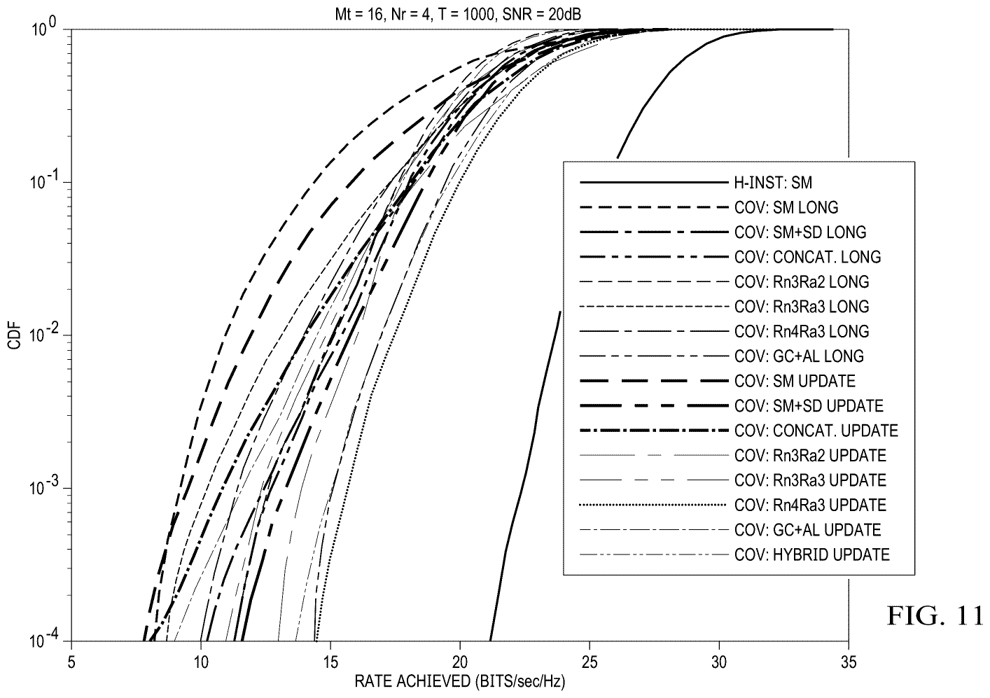

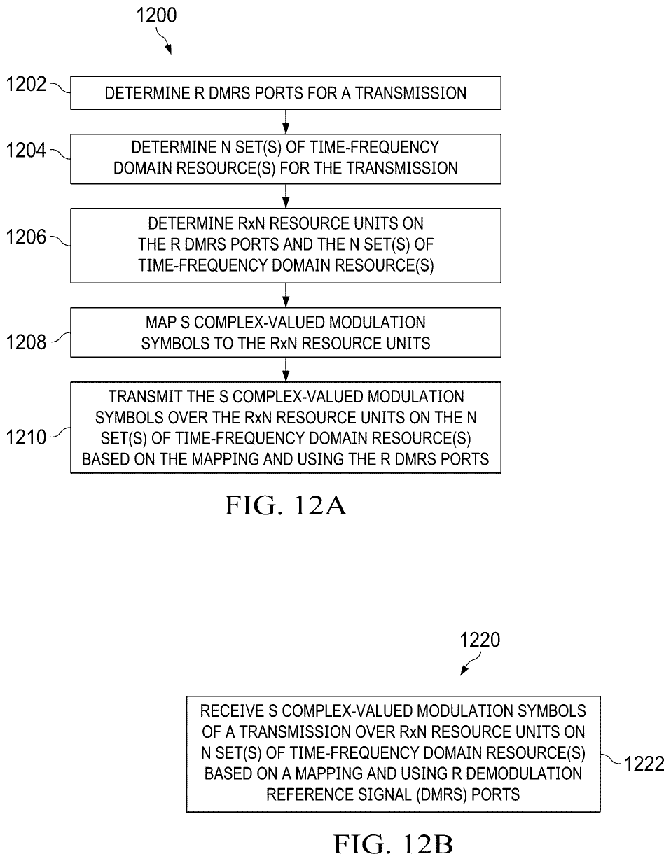

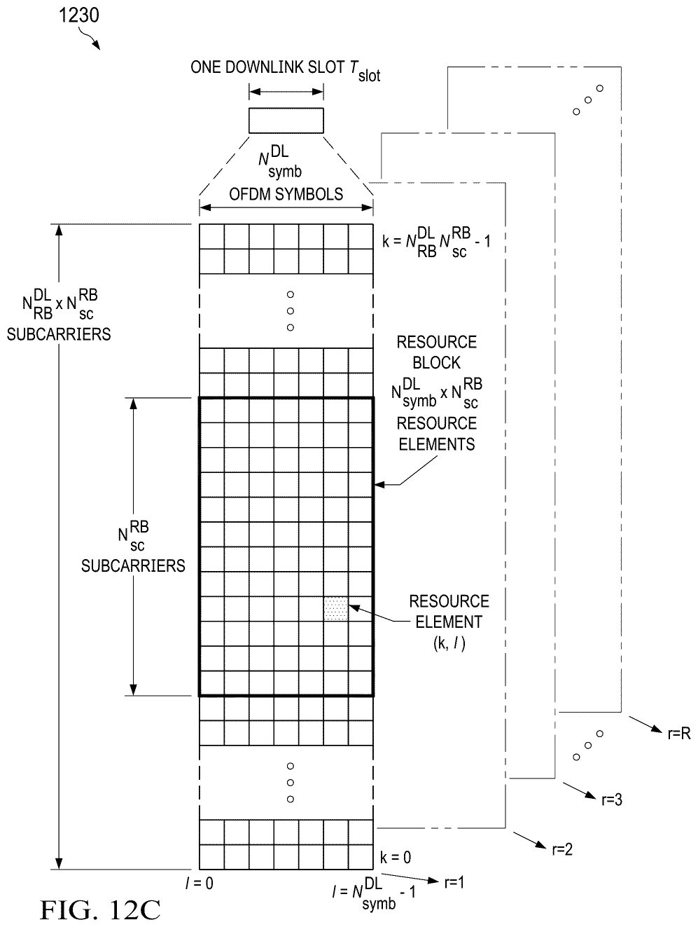

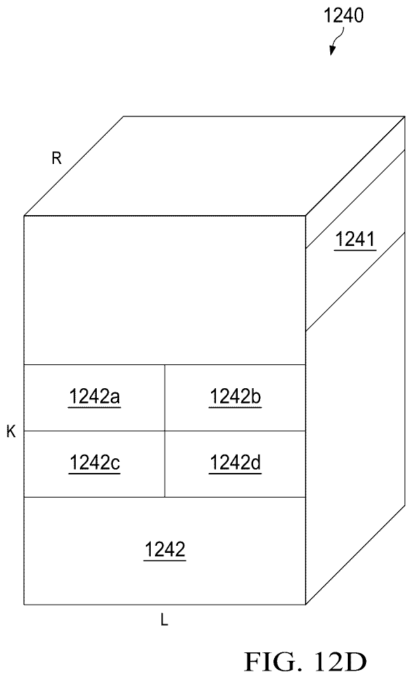

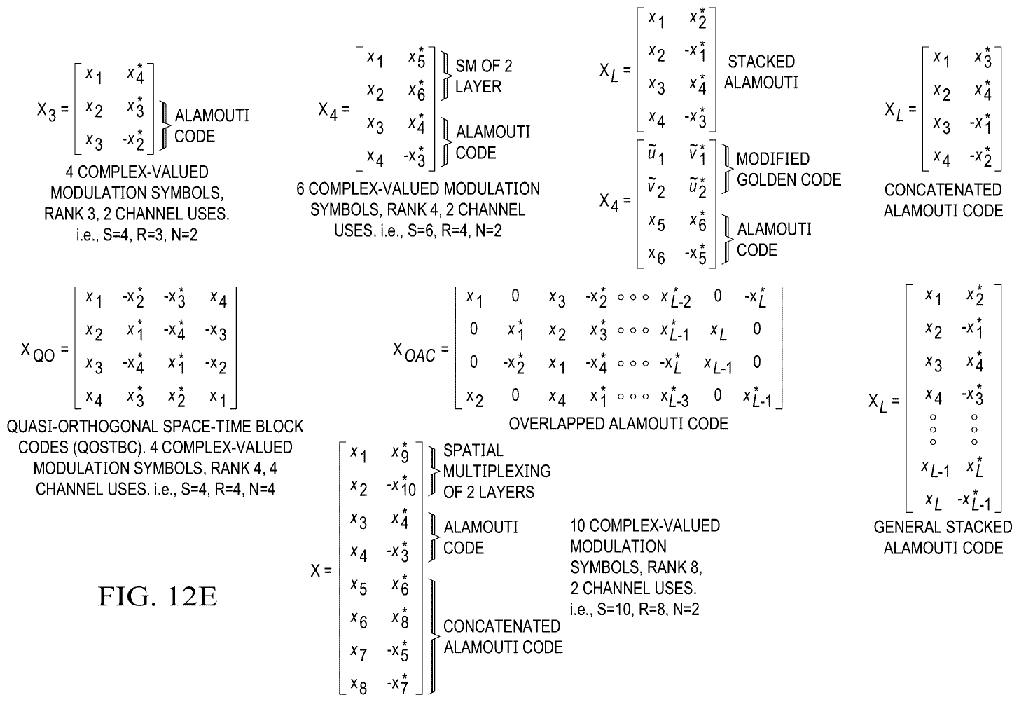

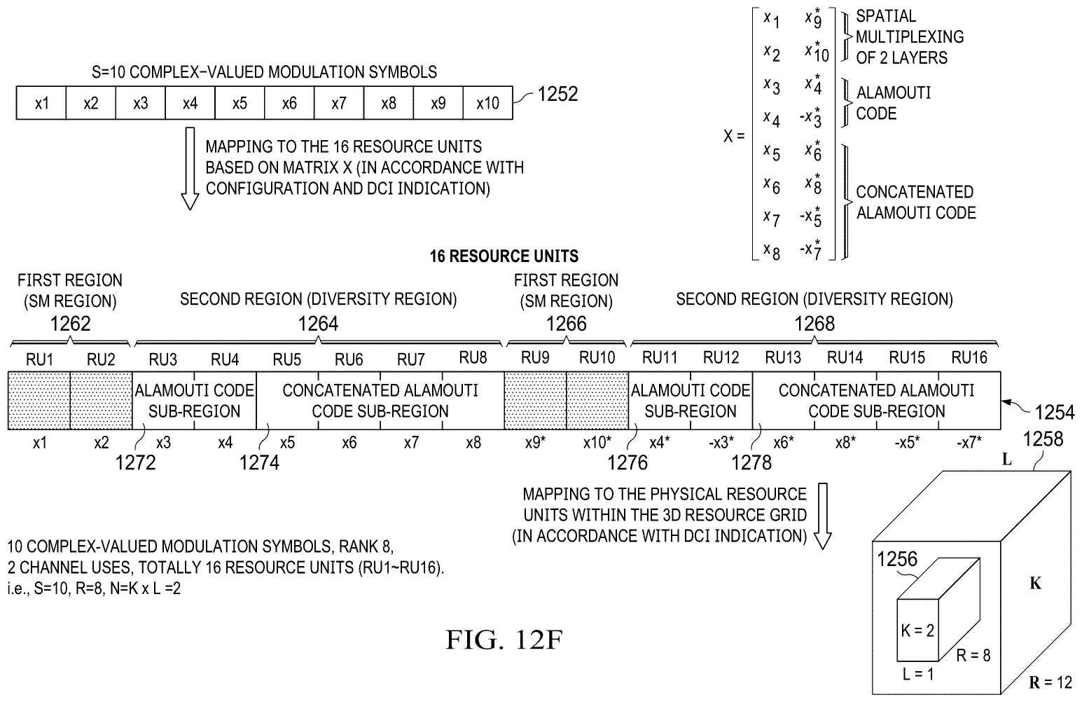

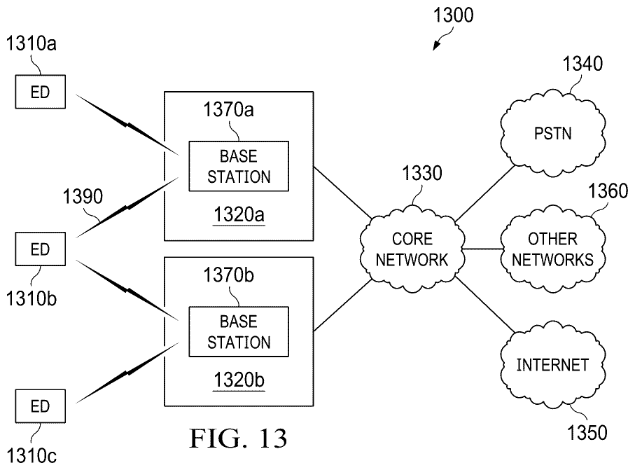

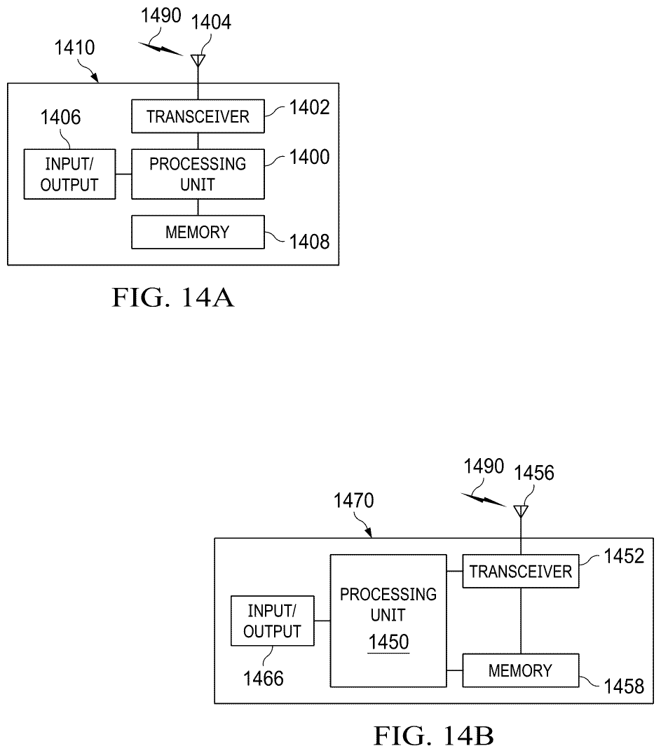

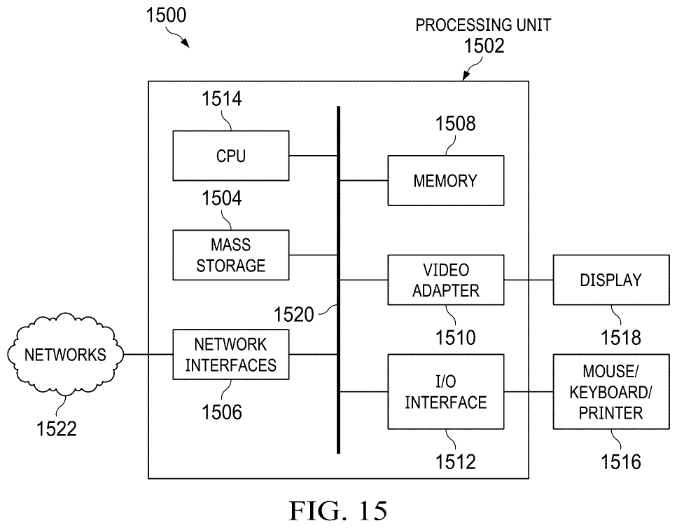

FIGS. 10A and 10B plot the rate CDF for the CDL-A channels with 0 dB and 10 dB SNR values. For all cases, the hybrid scheme provides the best lower tail rate performances.

Rate CDF with 30 km/h UE Speed

FIG. 11 plots the rate CDF for the CDL-A channels with UE speed of 30 km/h. For higher UE speed, the channel is changing much faster than previous case. However, the proposed hybrid scheme still provides the best lower tail rate performance compared to all other covariance based schemes.

FIG. 12A illustrates a flow chart of a method 1200 performed by a communication entity (such as the base station 152), according to embodiments. The communication entity may include computer-readable code or instructions executing on one or more processors of the communication entity. Coding of the software for carrying out or performing the method 1200 is well within the scope of a person of ordinary skill in the art having regard to the present disclosure. The method 1200 may include additional or fewer operations than those shown and described and may be carried out or performed in a different order. Computer-readable code or instructions of the software executable by the one or more processors may be stored on a non-transitory computer-readable medium, such as for example, the memory of the communication entity.

The method 1200 starts at the operation 1202, where the communication entity determines R demodulation reference signal (DMRS) ports for a transmission. R is greater than or equal to 2. At the operation 1204, the communication entity determines N set(s) of time-frequency domain resource(s) for the transmission. N is greater than or equal to 1. At the operation 1206, the communication entity determines RxN resource units on the R DMRS ports and the N set(s) of time-frequency domain resource(s). RxN is greater than or equal to 3.

At the operation 1208, the communication entity maps S complex-valued modulation symbols to the RxN resource units. S is less than RxN. For s from 1 to S, an s-th complex-valued modulation symbol is mapped to a quantity of r_s resource unit(s), r_s is greater than or equal to 1. For at least one s, r_s is greater than 1. RxN is greater than or equal to 5 if all r_s are equal. In some embodiments, a sum of all values of r_s is RxN. In some other embodiments, a sum of all values of r_s is less than RxN: that is, the RxN resource units are not completely filled up by the modulation symbols, and zero-padding(s) may be used (such as in the case of Overlapped Alamouti Code described below).

At the operation 1210, the communication entity transmits, to an apparatus, the S complex-valued modulation symbols over the RxN resource units on the N set(s) of time-frequency domain resource(s) based on the mapping and using the R DMRS ports.

In some embodiments, R and N may be adaptively obtained based on channel condition information and ultra-reliable low latency communications (URLLC) requirements.

In some embodiments, the channel condition information may be obtained based on at least one of a sounding reference signal (SRS) or a channel state information (CSI) report received from the apparatus.

In some embodiments, each DMRS port of the R DMRS ports may correspond to a layer or transmission layer in a spatial domain.

In some embodiments, each resource unit of the RxN resource units may correspond to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in the time domain.

In some embodiments, the R DMRS ports may correspond to a subset of a set of the first number of antenna ports. For example, the communication system may support up to R antenna ports/layers, where R=12, which is the first number of antenna ports. But, for a particular transmission to a UE from the gNB, only a subset of the 12 ports may be used (e.g., 3 ports of {3, 4, 5}). Then, in this case, R=3.

In some embodiments, each resource unit of the 3D resource grid may be uniquely identified by (r, k, l), for which r is a first index in the spatial domain, k is a second index in the frequency domain relative to a second reference point, and l is a third index in the time domain relative to a third reference point.

In some embodiments, the 3D resource grid may be defined for a first OFDM numerology including at least one of a subcarrier spacing value or a cyclic prefix value, a first carrier, and a first transmission direction of one of an uplink, downlink, or sidelink direction.

In some embodiments, the RxN resource units may include a first region configured as a spatial multiplexing region. A first complex-valued modulation symbol on the first region may be mapped to only 1 resource unit.

In some embodiments, the mapping the S complex-valued modulation symbols to the RxN resource units may include mapping a first set of one or more of the S complex-valued modulation symbols onto a subset of the resource unit(s) in the first region. A corresponding r_s is 1 for each of the first set of the one or more of the S complex-valued modulation symbols.

In some embodiments, the RxN resource units may include a second region configured as a diversity region. A second complex-valued modulation symbol on the second region may be mapped to more than 1 resource unit.

In some embodiments, the communication entity may map a second set of one or more of the S complex-valued modulation symbols onto a subset of the resource unit(s) in the second region. A corresponding r_s is greater than 1 for each of the second set of the one or more of the S complex-valued modulation symbols.

In some embodiments, the communication entity may map a second set of one or more of the S complex-valued modulation symbols onto a subset of the resource unit(s) in the second region, using at least one of Alamouti Code, Stacked Alamouti Code, Concatenated Alamouti Code, General Stacked Alamouti Code, Quasi-Orthogonal Space-Time Block Codes (QOSTBC), or Overlapped Alamouti Code.

In some embodiments, the second region may include at least one sub-region, and each of the at least one sub-region is one of an Alamouti Code sub-region, a Stacked Alamouti Code sub-region, a Concatenated Alamouti Code sub-region, a General Stacked Alamouti Code sub-region, a Quasi-Orthogonal Space-Time Block Codes (QOSTBC) sub-region, or an Overlapped Alamouti Code sub-region. Each sub-region of the at least one sub-region may include more than 1 resource unit.

In some embodiments, the second region may comprise at least one of: a 4-resource unit Alamouti Code space-time sub-region with 2 consecutive indexes in a spatial domain and 2 consecutive indexes in the time domain, 4 complex-valued modulation symbols mapped on the 4-resource unit Alamouti Code space-time sub-region according to Alamouti code; a 4-resource unit Alamouti Code space-frequency sub-region with 2 consecutive indexes in the spatial domain and 2 consecutive indexes in the frequency domain, 4 complex-valued modulation symbols mapped on the 4-resource unit Alamouti Code space-frequency sub-region according to the Alamouti code; an 8-resource unit Concatenated Alamouti Code space-time sub-region with 4 consecutive indexes in the spatial domain and 2 consecutive indexes in the time domain, 8 complex-valued modulation symbols mapped on the 8-resource unit Concatenated Alamouti Code space-time sub-region according to Concatenated Alamouti code; or an 8-resource unit Concatenated Alamouti Code space-frequency sub-region with 4 consecutive indexes in the spatial domain and 2 consecutive indexes in the frequency domain, 8 complex-valued modulation symbols mapped on the 8-resource unit Concatenated Alamouti Code space-frequency sub-region according to the Concatenated Alamouti code; or an m-resource unit repetition sub-region on which 1 complex-valued modulation symbol is mapped according to repetition.

In some embodiments, the communication entity may transmit, to the apparatus, control information for the transmission in one of a radio resource control (RRC) message, a downlink control information (DCI) message, or a media access control (MAC) message.

In some embodiments, the communication entity may transmit, to the apparatus, the control information including configuration related to a 3D resource grid in one of the RRC message, the DCI message, or the MAC message.

In some embodiments, the communication entity may transmit, to the apparatus, the control information including indication related to the N set(s) of time-frequency domain resource(s), and regions and sub-regions of the RxN resource units in one of the RRC message or the MAC message.

In some embodiments, the communication entity may transmit, to the apparatus, the control information including information for receiving the S complex-valued modulation symbols and the mapping in the DCI message or the MAC message.

In some embodiments, the communication entity may transmit, to the apparatus, the control information including indication related to the R DMRS ports as a subset of a set of a first number of antenna ports in at least one of the MAC message or the DCI message. For example, the communication system may support up to [symbol] antenna ports/layers, where [symbol] =12, which is the first number of antenna ports. But, for a particular transmission to a UE from the gNB, only a subset of the 12 ports may be used (e.g., 3 ports of {3, 4, 5}). Then, in this case, R=3, and the 3 ports {3, 4, 5} may be indicated in the DCI (e.g., DCI format 1_1 or the like) from the gNB to the receive UE. In some embodiments, the indicated ports may not be necessarily consecutive (e.g., the R ports may be {0, 3, 6}, i.e., r0=0, r1=3, r2=6). In some embodiments, for convenience, the R ports may be re-indexed in a consecutive way such as r0′=0, r1′=1, and r2′=2.

In some embodiments, each set of time-frequency domain resource may be a resource element in a 2-dimensional (2D) resource grid of a second number of subcarriers in the frequency domain and a third number of OFDM symbols in the time domain.

FIG. 12B illustrates a flow chart of a method 1220 performed by an apparatus (such as the UE 154 or a chip on the UE 154), according to embodiments. The apparatus may include computer-readable code or instructions executing on one or more processors of the apparatus. Coding of the software for carrying out or performing the method 1220 is well within the scope of a person of ordinary skill in the art having regard to the present disclosure. The method 1220 may include additional or fewer operations than those shown and described and may be carried out or performed in a different order. Computer-readable code or instructions of the software executable by the one or more processors may be stored on a non-transitory computer-readable medium, such as for example, the memory of the apparatus.

At the operation 1222, the apparatus receives, from a communication entity, S complex-valued modulation symbols of a transmission over RxN resource units on N set(s) of time-frequency domain resource(s) based on a mapping and using R demodulation reference signal (DMRS) ports. R is greater than or equal to 2. N is greater than or equal to 1. RxN is greater than or equal to 3. The mapping includes a first mapping from the S complex-valued modulation symbols to the RxN resource units. S is less than RxN. For s from 1 to S, an s-th complex-valued modulation symbol is mapped to a quantity of r_s resource unit(s), r_s is greater than or equal to 1. For at least one s, r_s is greater than 1. RxN is greater than or equal to 5 if all r_s are equal.

In some embodiments, R and N may be adaptively obtained based on channel condition information and ultra-reliable low latency communications (URLLC) requirements.

In some embodiments, the channel condition information may be obtained based on at least one of a sounding reference signal (SRS) or a channel state information (CSI) report received from the apparatus.

In some embodiments, each DMRS port of the R DMRS ports may correspond to a layer or transmission layer in a spatial domain.

In some embodiments, each resource unit of the RxN resource units may correspond to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in the time domain.

In some embodiments, the R DMRS ports may correspond to a subset of a set of the first number of antenna ports.

In some embodiments, each resource unit of the 3D resource grid may be uniquely identified by (r, k, l), for which r is a first index in the spatial domain, k is a second index in the frequency domain relative to a second reference point, and l is a third index in the time domain relative to a third reference point.

In some embodiments, the 3D resource grid may be defined for a first OFDM numerology including at least one of a subcarrier spacing value or a cyclic prefix value, a first carrier, and a first transmission direction of one of an uplink, downlink, or sidelink direction.

In some embodiments, the RxN resource units may include a first region configured as a spatial multiplexing region. A first complex-valued modulation symbol on the first region may be mapped to only 1 resource unit.

In some embodiments, the mapping may include a second mapping from a first set of one or more of the S complex-valued modulation symbols onto a subset of the resource unit(s) in the first region. A corresponding r_s is 1 for each of the first set of the one or more of the S complex-valued modulation symbols.

In some embodiments, the RxN resource units may include a second region configured as a diversity region. A second complex-valued modulation symbol on the second region may be mapped to more than 1 resource unit.

In some embodiments, the mapping may include a second mapping from a second set of one or more of the S complex-valued modulation symbols onto a subset of the resource unit(s) in the second region. A corresponding r_s is greater than 1 for each of the second set of the one or more of the S complex-valued modulation symbols.

In some embodiments, the mapping may include a second mapping from a second set of one or more of the S complex-valued modulation symbols onto a subset of the resource unit(s) in the second region, using at least one of Alamouti Code, Stacked Alamouti Code, Concatenated Alamouti Code, General Stacked Alamouti Code, Quasi-Orthogonal Space-Time Block Codes (QOSTBC), or Overlapped Alamouti Code.

In some embodiments, the second region may include at least one sub-region, and each of the at least one sub-region is one of an Alamouti Code sub-region, a Stacked Alamouti Code sub-region, a Concatenated Alamouti Code sub-region, a General Stacked Alamouti Code sub-region, a Quasi-Orthogonal Space-Time Block Codes (QOSTBC) sub-region, or an Overlapped Alamouti Code sub-region. Each sub-region of the at least one sub-region may include more than 1 resource unit.

In some embodiments, the second region may comprise at least one of: a 4-resource unit Alamouti Code space-time sub-region with 2 consecutive indexes in a spatial domain and 2 consecutive indexes in the time domain, 4 complex-valued modulation symbols mapped on the 4-resource unit Alamouti Code space-time sub-region according to Alamouti code; a 4-resource unit Alamouti Code space-frequency sub-region with 2 consecutive indexes in the spatial domain and 2 consecutive indexes in the frequency domain, 4 complex-valued modulation symbols mapped on the 4-resource unit Alamouti Code space-frequency sub-region according to the Alamouti code; an 8-resource unit Concatenated Alamouti Code space-time sub-region with 4 consecutive indexes in the spatial domain and 2 consecutive indexes in the time domain, 8 complex-valued modulation symbols mapped on the 8-resource unit Concatenated Alamouti Code space-time sub-region according to Concatenated Alamouti code; or an 8-resource unit Concatenated Alamouti Code space-frequency sub-region with 4 consecutive indexes in the spatial domain and 2 consecutive indexes in the frequency domain, 8 complex-valued modulation symbols mapped on the 8-resource unit Concatenated Alamouti Code space-frequency sub-region according to the Concatenated Alamouti code.

In some embodiments, the apparatus may receive, from the communication entity, control information for the transmission in one of a radio resource control (RRC) message, a downlink control information (DCI) message, or a media access control (MAC) message.

In some embodiments, the apparatus may receive, from the communication entity, the control information including configuration related to a 3D resource grid in one of the RRC message, the DCI message, or the MAC message.

In some embodiments, the apparatus may receive, from the communication entity, the control information including indication related to the N set(s) of time-frequency domain resource(s), and regions and sub-regions of the RxN resource units in one of the RRC message or the MAC message.

In some embodiments, the apparatus may receive, from the communication entity, the control information including information for receiving the S complex-valued modulation symbols and the mapping in the DCI message or the MAC message.

In some embodiments, the apparatus may receive, from the communication entity, the control information including indication related to the R DMRS ports as a subset of a set of a first number of antenna ports in at least one of the MAC message or the DCI message.

In some embodiments, each set of time-frequency domain resource may be a resource element in a 2-dimensional (2D) resource grid of a second number of subcarriers in the frequency domain and a third number of OFDM symbols in the time domain.

In some embodiments, the channel condition information may include at least a covariance matrix, obtained based on at least one of a sounding reference signal (SRS) or a channel state information (CSI) report received from the apparatus. The covariance matrix may be updated at least when a SRS or CSI report is received. The covariance matrix may be a wideband covariance matrix or a subband covariance matrix. It may be the same for all the resource units in the 3D resource grid or different. Interpolation, extrapolation, and/or prediction may be used to obtain a different channel condition information on a resource unit.

In some embodiments, the communication entity may precode the S complex-valued modulation symbols using R eigenvectors from Eigen Value Decomposition (EVD) of the covariance matrix and the r-th (or r′-th) eigenvector for the precoding of the r-th (or r′-th) DMRS port.

In some embodiments, the communication entity may transmits the S complex-valued modulation symbols over the RxN resource units on the N set(s) of time-frequency domain resource(s) based on the precoding.

In some embodiments, the regions and sub-regions may be pre-configured/pre-defined before and/or after the channel condition information is obtained, before and/or after the S complex-valued modulation symbols are obtained, etc.

FIG. 12C illustrates a 3D resource grid 1230, according to embodiments. Each resource unit in the 3D resource grid 1230 is uniquely identified by (r, k, l). The first index r is an index in the spatial domain, ranging from 1 to R. The second index k is an index in the frequency domain, ranging from o to K=N_{RB}^{DL}N_{SC}^{RB}−1. The third index 1 is in the time domain, ranging from o to L=N_{symb}^{DL}−1.

FIG. 12D illustrates a 3D resource grid 1240 of size R×K×L, according to embodiments. The 3D resource grid 1240 may include multiple regions, such as the first region 1241 and the second region 1242. In some embodiments, the first region 1241 may be configured as a spatial multiplexing region, and a first complex-valued modulation symbol on the first region 1241 may be mapped to only 1 resource unit. In some embodiments, the second region 1242 may be configured as a diversity region, and a second complex-valued modulation symbol on the second region may be mapped to more than 1 resource unit. One region may further include multiple sub-regions. For example, the second region 1242 may include sub-regions 1242a, 1242b, 1242c, and 1242d.

In embodiments, the base station may distribute S complex-valued modulation symbols on the MIMO channel with a rank R (e.g., R strong eigenvalues) and N transmissions in time/frequency, adaptively using spatial multiplexing, spatial diversity, and time/frequency diversity. The adaptation may be based on the URLLC requirements, channel conditions, etc. The precoding may be based on the covariance matrix, and, optionally, also on the latest instantaneous channel. In addition, power-domain optimization may be incorporated. FIG. 12E shows various codes that may be used for precoding, according to embodiments. In FIG. 12E, the subscripts inside the matrices are for the complex-valued modulation symbols, the vertical direction is via MIMO subspaces corresponding to the spatial domain antenna ports R (or rank R, transmission rank R, spatial rank R, or layers R, spatial layers R, transmission layers R, etc.), and the horizontal direction is via channel uses in time or frequency resources corresponding to time-frequency domain resources of N sets. For example, for the first example of X3, S=4, R=3, N=2. Sub-blocks of a matrix may be for different regions/sub-regions (e.g., for the matrix X, X may include a spatial multiplexing region and diversity region, the latter further including an Alamouti Code sub-region and a Concatenated Alamouti Code sub-region). X may have S=10, R=8, N=2. The N=2 sets of resources may be 2 resource elements (REs) in time domain or frequency domain. For the matrix X_{Q0}, it may have N=4, and there may be 4 REs in the time domain, or 4 REs in the frequency domain, or 2 REs in the time domain and 2 REs in the frequency domain. In general, the N REs may be mapped to time-frequency domains in rather general ways, such as only in the frequency domain, only in the time domain, in both the time-frequency domain, consecutive, non-consecutive, scrambled in the ordering or not scrambled, according to existing standards, etc.

FIG. 12F shows mapping of complex-valued modulation symbols 1252 to resource units 1254 and to physical resource units 1256 within the 3D resource grid 1258, according to some embodiments. As an illustrative example, FIG. 12F shows that complex-valued modulation symbols S 1252 may include 10 complex-valued modulation symbols x₁ to x₁₀. The 10 complex-valued modulation symbols S 1252 may be determined by the gNB to be transmitted on a MIMO channel of the rank of 8 (e.g., 8 strong eigenvalues) with 2 channel uses (i.e., S=10, R=8, N=K×L=2). So, totally 16 resource units (RU1-RU16) may be mapped to. The gNB decision of the rank and channel uses may be based on channel condition information (of the covariance matrix of the channel, the latest instantaneous CSI of the channel if available/relevant, or a mixture of those) and ultra-reliable low latency communications (URLLC) requirements. The rank 8 may correspond to 8 DMRS ports of a PDSCH transmission (i.e., the PDSCH data of the transmission is the complex-valued modulation symbols, and the PDSCH data is to be demodulated by the UE based on the 8 DMRS port of the PDSCH). The transmission of the complex-valued modulation symbols may be in UL in some other embodiments, then the symbols are the PUSCH data and are to be demodulated by the network based on the 8 DMRS ports of the PUSCH. The 2 channel uses may be 2 resource elements. There is a 1-1 correspondence between each DMRS port of the R DMRS ports and a layer or transmission layer in a spatial domain of the PDSCH/PUSCH.

By applying the matrix X shown in FIG. 12F, the 10 complex-valued modulation symbols S 1252 may be mapped to 16 resource units 1254. The use of the matrix X may be transmitted to the UE by using, for example, a DCI message. In an example embodiment, the matrix X may include a submatrix corresponding to the spatial multiplexing of 2 layers. The matrix X may further include a submatrix of Alamouti Code. The matrix X may additionally include a submatrix of Concatenated Alamouti code. The structure of the matrix X (e.g., a stacked matrix with a submatrix for spatial multiplexing and a submatrix for Alamouti Code and so on) may be pre-configured by the network to the UE, and multiple possible such matrix structures may be pre-configured. Each possible matrix structure may be associated with an index. Then, one index may be sent in a DCI message to inform the UE about a matrix structure. The parameters of the matrix X (e.g., the number of layers for spatial multiplexing, the parameter L in FIG. 12E for General Stacked Alamouti Code, etc.) may be signaled from the network to the UE via the RRC/MAC/DCI message.

With the mapping described above, the resource units 1254 may include 16 resource units, RU1-RU16, which can be grouped into several regions. For example, the resource units 1254 may include the first region 1262, the second region 1264, the first region 1266, and the second region 1268. The first region 1262 may be an SM region including RU1 and RU2, corresponding to symbols x1 and x2, respectively. The second region 1264 may be a diversity region, including the Alamouti Code sub-region 1272 and the Concatenated Alamouti Code sub-region 1274. The Alamouti Code sub-region 1272 may include RU3 and RU4, corresponding to symbols x3 and x4, respectively. The Concatenated Alamouti code sub-region 1274 may include RU5 to RU8, corresponding to symbols x5-x8, respectively. The first region 1262 and the second region 1264 may be for the first channel use. The first region 1266 may be another SM region including RU9 and RU10, corresponding to symbols x9* and x10*, respectively. The second region 1268 may be another diversity region, including the Alamouti Code sub-region 1276 and the Concatenated Alamouti Code sub-region 1278. The Alamouti Code sub-region 1276 may include RU11 and RU12, corresponding to symbols x4* and −x3*, respectively. The Concatenated Alamouti code sub-region 1278 may include RU13, RU14, RU15, and RU16, corresponding to symbols x6*, x8*, −x5*, and −x7*, respectively. The first region 1266 and the second region 1268 may be for the second channel use. There may be a 1-to-1 correspondence between the mapping matrix X and the grouping of the regions/sub-regions of the resource units 1254 so that specifying either one is equivalent to specifying the other one. The grouping of the regions/sub-regions of the resource units, and/or the structure and parameters of the regions/sub-regions of the resource units, may be signaled from the network to the UE. In the SM region(s), each complex-valued modulation symbol may be mapped to exactly one resource unit. In the diversity region(s), each complex-valued modulation symbol is mapped to more than one resource unit (e.g., symbol x3 appears twice (as x3 in RU3 and as −x3* in RU12)). Therefore, the SM region(s) can support higher data rate, and the diversity region(s) can support higher reliability. Correspondingly, the resource units in the SM region(s) may be precoded via the strongest eigenvectors/singular vectors of the channel, and the resource units in the diversity region(s) may be precoded via the less strong eigenvectors/singular vectors of the channel.

FIG. 12F further shows how the physical resource units 1256 of the 16 resource units 1254, mapped from the complex-valued modulation symbols S 1252, are in a 3D resource grid 1258. The configuration related to the 3D resource grid 1258 may be transmitted to the UE using one of an RRC message, a DCI message, or a MAC message. That mapping of the complex-valued modulation symbols S 1252 to the physical resource units within the 3D resource grid 1258, (i.e., the location/allocation (which does not have to be consecutive in the time-frequency-spatial domain, or which may also be scrambled in the time-frequency-spatial domain) of the physical resource units 1256 within the 3D resource grid 1258) may be signaled via a DCI message.

FIG. 13 illustrates an example communication system 1300. In general, the system 1300 enables multiple wireless or wired users to transmit and receive data and other content. The system 1300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1300 includes electronic devices (ED) 1310a-1310c, radio access networks (RANs) 1320a-1320b, a core network 1330, a public switched telephone network (PSTN) 1340, the Internet 1350, and other networks 1360. While certain numbers of these components or elements are shown in FIG. 13, any number of these components or elements may be included in the system 1300.

The EDs 1310a-1310c are configured to operate or communicate in the system 1300. For example, the EDs 1310a-1310c are configured to transmit or receive via wireless or wired communication channels. Each ED 1310a-1310c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1320a-1320b here include base stations 1370a-1370b, respectively. Each base station 1370a-1370b is configured to wirelessly interface with one or more of the EDs 1310a-1310c to enable access to the core network 1330, the PSTN 1340, the Internet 1350, or the other networks 1360. For example, the base stations 1370a-1370b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1310a-1310c are configured to interface and communicate with the Internet 1350 and may access the core network 1330, the PSTN 1340, or the other networks 1360.

In the embodiment shown in FIG. 13, the base station 1370a forms part of the RAN 1320a, which may include other base stations, elements, or devices. Also, the base station 1370b forms part of the RAN 1320b, which may include other base stations, elements, or devices. Each base station 1370a-1370b operates to transmit or receive wireless signals within a particular geographic region or area, sometimes referred to as a “cell.” In some embodiments, multiple-input multiple-output (MIMO) technology may be employed having multiple transceivers for each cell.

The base stations 1370a-1370b communicate with one or more of the EDs 1310a-1310c over one or more air interfaces 1390 using wireless communication links. The air interfaces 1390 may utilize any suitable radio access technology.

It is contemplated that the system 1300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1320a-1320b are in communication with the core network 1330 to provide the EDs 1310a-1310c with voice, data, application, Voice over Internet Protocol (VoIP), or other services. Understandably, the RANs 1320a-1320b or the core network 1330 may be in direct or indirect communication with one or more other RANs (not shown). The core network 1330 may also serve as a gateway access for other networks (such as the PSTN 1340, the Internet 1350, and the other networks 1360). In addition, some or all of the EDs 1310a-1310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1350.

Although FIG. 13 illustrates one example of a communication system, various changes may be made to FIG. 13. For example, the communication system 1300 could include any number of EDs, base stations, networks, or other components in any suitable configuration.

FIGS. 14A and 14B illustrate example devices that may implement the methods and teachings according to this disclosure. In particular, FIG. 14A illustrates an example ED 1410, and FIG. 14B illustrates an example base station 1470. These components could be used in the system 1300 or in any other suitable system.

As shown in FIG. 14A, the ED 1410 includes at least one processing unit 1400. The processing unit 1400 implements various processing operations of the ED 1410. For example, the processing unit 1400 could perform signal coding, data processing, power control, input/output processing, or any other functionality enabling the ED 1410 to operate in the system 1300. The processing unit 1400 also supports the methods and teachings described in more detail above. Each processing unit 1400 includes any suitable processing or computing device configured to perform one or more operations. Each processing unit 1400 could, for example, include a microprocessor, microcontroller, digital signal processor, field programmable gate array, or application specific integrated circuit.

The ED 1410 also includes at least one transceiver 1402. The transceiver 1402 is configured to modulate data or other content for transmission by at least one antenna or NIC (Network Interface Controller) 1404. The transceiver 1402 is also configured to demodulate data or other content received by the at least one antenna 1404. Each transceiver 1402 includes any suitable structure for generating signals for wireless or wired transmission or processing signals received wirelessly or by wire. Each antenna 1404 includes any suitable structure for transmitting or receiving wireless or wired signals. One or multiple transceivers 1402 could be used in the ED 1410, and one or multiple antennas 1404 could be used in the ED 1410. Although shown as a single functional unit, a transceiver 1402 could also be implemented using at least one transmitter and at least one separate receiver.

The ED 1410 further includes one or more input/output devices 1406 or interfaces (such as a wired interface to the Internet 1350). The input/output devices 1406 facilitate interaction with a user or other devices (network communications) in the network. Each input/output device 1406 includes any suitable structure for providing information to or receiving information from a user, such as a speaker, microphone, keypad, keyboard, display, or touch screen, including network interface communications.

In addition, the ED 1410 includes at least one memory 1408. The memory 1408 stores instructions and data used, generated, or collected by the ED 1410. For example, the memory 1408 could store software or firmware instructions executed by the processing unit(s) 1400 and data used to reduce or eliminate interference in incoming signals. Each memory 1408 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 14B, the base station 1470 includes at least one processing unit 1450, at least one transceiver 1452, which includes functionality for a transmitter and a receiver, one or more antennas 1456, at least one memory 1458, and one or more input/output devices or interfaces 1466. A scheduler, which would be understood by one skilled in the art, is coupled to the processing unit 1450. The scheduler could be included within or operated separately from the base station 1470. The processing unit 1450 implements various processing operations of the base station 1470, such as signal coding, data processing, power control, input/output processing, or any other functionality. The processing unit 1450 can also support the methods and teachings described in more detail above. Each processing unit 1450 includes any suitable processing or computing device configured to perform one or more operations. Each processing unit 1450 could, for example, include a microprocessor, microcontroller, digital signal processor, field programmable gate array, or application specific integrated circuit.

Each transceiver 1452 includes any suitable structure for generating signals for wireless or wired transmission to one or more EDs or other devices. Each transceiver 1452 further includes any suitable structure for processing signals received wirelessly or by wire from one or more EDs or other devices. Although shown combined as a transceiver 1452, a transmitter and a receiver could be separate components. Each antenna 1456 includes any suitable structure for transmitting or receiving wireless or wired signals. While a common antenna 1456 is shown here as being coupled to the transceiver 1452, one or more antennas 1456 could be coupled to the transceiver(s) 1452, allowing separate antennas 1456 to be coupled to the transmitter and the receiver if equipped as separate components. Each memory 1458 includes any suitable volatile or non-volatile storage and retrieval device(s). Each input/output device 1466 facilitates interaction with a user or other devices (network communications) in the network. Each input/output device 1466 includes any suitable structure for providing information to or receiving/providing information from a user, including network interface communications.

FIG. 15 is a block diagram of a computing system 1500 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1500 includes a processing unit 1502. The processing unit includes a central processing unit (CPU) 1514, memory 1508, and may further include a mass storage device 1504, a video adapter 1510, and an I/O interface 1512 connected to a bus 1520.

The bus 1520 may be one or more of any type of several bus architectures including a memory bus or memory controller, a peripheral bus, or a video bus. The CPU 1514 may comprise any type of electronic data processor. The memory 1508 may comprise any type of non-transitory system memory such as static random access memory (SRAM), dynamic random access memory (DRAM), synchronous DRAM (SDRAM), read-only memory (ROM), or a combination thereof. In an embodiment, the memory 1508 may include ROM for use at boot-up, and DRAM for program and data storage for use while executing programs.

The mass storage 1504 may comprise any type of non-transitory storage device configured to store data, programs, and other information and to make the data, programs, and other information accessible via the bus 1520. The mass storage 1504 may comprise, for example, one or more of a solid state drive, hard disk drive, a magnetic disk drive, or an optical disk drive.

The video adapter 1510 and the I/O interface 1512 provide interfaces to couple external input and output devices to the processing unit 1502. As illustrated, examples of input and output devices include a display 1518 coupled to the video adapter 1510 and a mouse, keyboard, or printer 1516 coupled to the I/O interface 1512. Other devices may be coupled to the processing unit 1502, and additional or fewer interface cards may be utilized. For example, a serial interface such as Universal Serial Bus (USB) (not shown) may be used to provide an interface for an external device.

The processing unit 1502 also includes one or more network interfaces 1506, which may comprise wired links, such as an Ethernet cable, or wireless links to access nodes or different networks. The network interfaces 1506 allow the processing unit 1502 to communicate with remote units via the networks. For example, the network interfaces 1506 may provide wireless communication via one or more transmitters/transmit antennas and one or more receivers/receive antennas. In an embodiment, the processing unit 1502 is coupled to a local-area network 1522 or a wide-area network for data processing and communications with remote devices, such as other processing units, the Internet, or remote storage facilities.

The following references are incorporated in this disclosure by reference.
J. Jose, N. Prasad, M. Khojastepour, S. Rangarajan, “On Robust Weighted-Sum Rate Maximization in MIMO Interference Networks,” IEEE ICC 2011.
S. Christensen, R. Agarwal, E. Carvalho, and J. Cioffi, “Weighted sumrate maximization using weighted MMSE for MIMO-BC beamforming design,” IEEE Trans. Wireless Commun., vol. 7, no. 12, pp. 1-8, 2008.
Y. Eldar and N. Merhav, “A competitive minimax approach to robust estimation of random parameters,” IEEE Transactions on Signal Processing, vol. 52, no. 7, p. 1931, 2004.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a selecting unit or module, a determining unit or module, or an assigning unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A method, comprising:
mapping, by a communication entity, S complex-valued modulation symbols to RxN resource units, wherein the RxN resource units are associated with R demodulation reference signal (DMRS) ports for a transmission and N sets of one or more time-frequency domain resources for the transmission, wherein R is greater than or equal to 2, N is greater than or equal to 1, and RxN is greater than or equal to 3, wherein:
S is less than RxN,
for s from 1 to S, an s-th complex-valued modulation symbol is mapped to r_s resource units, r_s is greater than or equal to 1,
for at least one s, r_s is greater than 1,
a sum of all of r_s is RxN, and
RxN is greater than or equal to 5 if all r_s are equal; and
transmitting, by the communication entity to an apparatus, the S complex-valued modulation symbols over the RxN resource units on the N sets of time-frequency domain resources based on the mapping and using the R DMRS ports.

2. The method of claim 1, wherein R and N are adaptively obtained based on channel condition information and ultra-reliable low latency communications (URLLC) requirements.

3. The method of claim 2, wherein the channel condition information is obtained based on at least one of a sounding reference signal (SRS) or a channel state information (CSI) report received from the apparatus.

4. The method of claim 1, wherein each DMRS port of the R DMRS ports corresponds to a layer or transmission layer in a spatial domain.

5. The method of claim 1, wherein each resource unit of the RxN resource units corresponds to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in a time domain.

6. The method of claim 5, wherein the R DMRS ports correspond to a subset of a set of the first number of antenna ports.

7. The method of claim 5, wherein each resource unit of the 3D resource grid is uniquely identified by (r, k, l), wherein r represents a first index in the spatial domain, k represents a second index in the frequency domain relative to a second reference point, and l represents a third index in the time domain relative to a third reference point.

8. The method of claim 5, wherein the 3D resource grid is defined for a first OFDM numerology including at least one of a subcarrier spacing value or a cyclic prefix value, a first carrier, and a first transmission direction of one of a uplink, downlink, or sidelink direction.

9. The method of claim 1, wherein the RxN resource units comprises a first region configured as a spatial multiplexing region and a first complex-valued modulation symbol on the first region is mapped to only 1 resource unit.

10. The method of claim 9, further comprising:
mapping a first set of one or more of the S complex-valued modulation symbols onto a subset of one or more resource units in the first region, wherein a corresponding r_s is 1 for each of the first set of the one or more of the S complex-valued modulation symbols.

11. The method of claim 9, wherein the RxN resource units includes a second region configured as a diversity region and a second complex-valued modulation symbol on the second region is mapped to more than 1 resource unit.

12. The method of claim 11, further comprising:
mapping a second set of one or more of the S complex-valued modulation symbols onto a subset of one or more resource units in the second region, wherein a corresponding r_s is greater than 1 for each of the second set of the one or more of the S complex-valued modulation symbols.

13. The method of claim 11, wherein the second region includes at least one sub-region, and each of the at least one sub-region comprises:
an Alamouti Code sub-region,
a Stacked Alamouti Code sub-region,
a Concatenated Alamouti Code sub-region,
a General Stacked Alamouti Code sub-region,
a Quasi-Orthogonal Space-Time Block Codes (QOSTBC) sub-region, or
an Overlapped Alamouti Code sub-region, and
each sub-region of the at least one sub-region includes more than 1 resource unit.

14. The method of claim 13, the second region comprising:
a 4-resource unit Alamouti Code space-time sub-region with 2 consecutive indexes in a spatial domain and 2 consecutive indexes in a time domain, 4 complex-valued modulation symbols being mapped on the 4-resource unit Alamouti Code space-time sub-region according to Alamouti code,
a 4-resource unit Alamouti Code space-frequency sub-region with 2 consecutive indexes in the spatial domain and 2 consecutive indexes in the frequency domain, 4 complex-valued modulation symbols being mapped on the 4-resource unit Alamouti Code space-frequency sub-region according to the Alamouti code,
an 8-resource unit Concatenated Alamouti Code space-time sub-region with 4 consecutive indexes in the spatial domain and 2 consecutive indexes in the time domain, 8 complex-valued modulation symbols being mapped on the 8-resource unit Concatenated Alamouti Code space-time sub-region according to Concatenated Alamouti code, or an 8-resource unit Concatenated Alamouti Code space-frequency sub-region with 4 consecutive indexes in the spatial domain and 2 consecutive indexes in the frequency domain, 8 complex-valued modulation symbols being mapped on the 8-resource unit Concatenated Alamouti Code space-frequency sub-region according to the Concatenated Alamouti code.

15. The method of claim 1, further comprising transmitting, by the communication entity, control information for the transmission, wherein transmitting the control information comprises:
transmitting, by the communication entity to the apparatus, the control information comprising an indication related to the N sets of one or more time-frequency domain resources, and regions and sub-regions of the RxN resource units in one of a RRC message or a MAC message.

16. The method of claim 1, further comprising transmitting, by the communication entity, control information for the transmission, wherein transmitting the control information comprises:
transmitting, by the communication entity to the apparatus, the control information including information for receiving the S complex-valued modulation symbols and the mapping in a DCI message or a MAC message.

17. The method of claim 1, wherein each set of time-frequency domain resources comprises a resource element in a 2-dimensional (2D) resource grid of a second number of subcarriers in the frequency domain and a third number of OFDM symbols in a time domain.

18. At least one non-transitory computer readable storage medium storing programming, the programming including instructions that, when executed by at least one processor, configures the at least one processor to:
map S complex-valued modulation symbols to RxN resource units, wherein the RxN resource units are associated with R demodulation reference signal (DMRS) ports for a transmission and N sets of one or more time-frequency domain resources for the transmission, wherein R is greater than or equal to 2, N is greater than or equal to 1, and RxN is greater than or equal to 3, wherein:
S is less than RxN,
for s from 1 to S, an s-th complex-valued modulation symbol is mapped to r_s resource units, r_s is greater than or equal to 1,
for at least one s, r_s is greater than 1,
a sum of all of r_s is RxN, and
RxN is greater than or equal to 5 if all r_s are equal; and
cause transmission, to an apparatus, the S complex-valued modulation symbols over the RxN resource units on the N sets of time-frequency domain resources based on the map and using the R DMRS ports.

19. An apparatus, comprising:
at least one processor; and
at least one non-transitory computer readable storage medium storing programming, the programming including instructions that, when executed by the at least one processor, cause the apparatus to:
map S complex-valued modulation symbols to RxN resource units, wherein the RxN resource units are associated with R demodulation reference signal (DMRS) ports for a transmission and N sets of one or more time-frequency domain resources for the transmission, wherein R is greater than or equal to 2, N is greater than or equal to 1, and RxN is greater than or equal to 3, wherein:
S is less than RxN,
for s from 1 to S, an s-th complex-valued modulation symbol is mapped to r_s resource units, r_s is greater than or equal to 1,
for at least one s, r_s is greater than 1,
a sum of all of r_s is RxN, and
RxN is greater than or equal to 5 if all r_s are equal; and
transmit, to another apparatus, the S complex-valued modulation symbols over the RxN resource units on the N sets of time-frequency domain resources based on the map and using the R DMRS ports.

20. The apparatus of claim 19, wherein each resource unit of the RxN resource units corresponds to a corresponding unit in a 3-dimensional (3D) resource grid of a first number of antenna ports in a spatial domain, a second number of subcarriers in the frequency domain, and a third number of orthogonal frequency-division multiplexing (OFDM) symbols in a time domain.
